(19) United States
(12) Patent Application Publication
(10) Pub. No.: US 2013/0016058 A1
(43) Pub. Date: Jan. 17, 2013

(54) ELECTRONIC DEVICE, DISPLAY METHOD AND COMPUTER-READABLE RECORDING MEDIUM STORING DISPLAY PROGRAM

(71) Applicant: Masaki Yamamoto, Osaka-shi (JP)

(72) Inventor: Masaki Yamamoto, Osaka-shi (JP)

(73) Assignee: SHARP KABUSHIKI KAISHA, Osaka-shi, Osaka (JP)

(21) Appl. No.: 13/637,312

(22) PCT Filed: Mar. 8, 2011
(86) PCT No.: PCT/JP2011/055381

§ 371 Date: Sep. 25, 2012

(30) Foreign Application Priority Data
Apr. 22, 2010 (JP) 2010-098534
Apr. 22, 2010 (JP) 2010-098535

(51) Int. Cl. G06F 3/041

(52) U.S. Cl. 345/173

(57) ABSTRACT

A display device includes a memory, a touch panel on which a background image is displayed, and a processor for receiving input of a hand-drawn image through the touch panel and causing the touch panel to display the background image and the hand-drawn image to overlap each other. The display device receives input of an instruction to delete the hand-drawn image superimposed on the background image, stores in the memory as history information the background image and the hand-drawn image having been displayed on the touch panel when the instruction is input, and causes the touch panel to display the background image and the hand-drawn image to overlap each other based on the history information.

### TECHNICAL FIELD

The present invention relates to an electronic device capable of reproducing moving images, a display method and a display program, and more particularly relates to an electronic device capable of displaying a hand-drawn image, a display method and a computer-readable recording medium storing a display program.

### BACKGROUND ART

There is a known display device capable of displaying moving images by receiving one-segment broadcasting or receiving streaming data.

There is also a known network system in which a plurality of display devices connectable to the Internet exchange a hand-drawn image with one another in real time.

Examples of the network system include a server/client system, a P2P (Peer to Peer) system and the like. In such network systems, each of the display devices transmits and receives a hand-drawn image, text data, and the like. Each of the display devices causes a display to display hand-drawn images and texts based on the received data. For example, Japanese Patent Laying-Open No. 2006-4190 (PTL 1) discloses a chat service system for mobile phones. According to Japanese Patent Laying-Open No. 2006-4190 (PTL 1), there are provided a distribution server forming a moving image display region and a character display region on a browser display screen of each of a large number of mobile phone terminals and operator's web terminals communicatively connected via the Internet and distributing moving image data to be displayed streamingly on the above-mentioned moving image display region, as well as a chat server supporting chats between the above-mentioned mobile phone terminals and the above-mentioned operator's web terminals and causing chat data composed of character data to be displayed in the above-mentioned character display region. As to the above-mentioned chat server, each of the operator's web terminals forms an independent chat channel for every mobile phone terminal of the plurality of mobile phone terminals.

### CITATION LIST

### Patent Literature

PTL 1: Japanese Patent Laying-Open No. 2006-4190

### SUMMARY OF INVENTION

### Technical Problem

A user in some cases would like to draw a hand-drawn image on a moving image. The user in some cases would like to draw a hand-drawn image related to a scene or a frame of a moving image being reproduced. However, after an input hand-drawn image is deleted or after the scene of a moving image is changed, for example, it is conventionally impossible to browse the hand-drawn image input in the past together with a corresponding moving image.

The present invention has been made to solve the above-described problem, and has an object related to an electronic device that enables browsing of a hand-drawn image input in the past together with a corresponding moving image, a display method, and a computer-readable recording medium storing a display program.

### Solution to Problem

According to an aspect of the present invention, an electronic device is provided which comprises: a memory; a touch panel on which a background image is displayed; and a processor for receiving input of a hand-drawn image through the touch panel and causing the touch panel to display the background image and the hand-drawn image to overlap each other. The processor is configured to receive input of an instruction to delete the hand-drawn image superimposed on the background image, store in the memory as history information the background image and the hand-drawn image having been displayed on the touch panel when the instruction is input, and cause the touch panel to display the background image and the hand-drawn image to overlap each other based on the history information.

Preferably, the touch panel displays a moving image. The background image includes a frame of a moving image.

Preferably, when a scene of the moving image being displayed on the touch panel is changed, the processor stores a frame of the moving image and the hand-drawn image having been displayed on the touch panel immediately before the change, in the memory as the history information.

Preferably, the processor deletes the hand-drawn image on the moving image when the scene of the moving image is changed.

Preferably, the processor deletes the hand-drawn image on the background image in accordance with the instruction.

Preferably, while causing the background image to be displayed in a first region of the touch panel, the processor is configured to cause the hand-drawn image to be displayed to overlap the background image, and cause the background image and the hand-drawn image to be displayed to overlap each other in a second region of the touch panel based on the history information.

Preferably, the electronic device further includes an antenna for externally receiving the background image.

Preferably, the electronic device further includes a communication interface for communicating with another electronic device via a network. The processor is configured to transmit the hand-drawn image input through the touch panel to another electronic device via the communication interface, and receive a hand-drawn image from another electronic device, cause the touch panel to display the hand-drawn image input through the touch panel and the hand-drawn image from another electronic device to overlap the background image, and store the hand-drawn image from another electronic device in the memory as the history information together with the hand-drawn image input through the touch panel.

Preferably, the processor stores paint data having the hand-drawn image and the background image combined with each other in the memory as the history information. Preferably, the processor associates paint data showing the hand-drawn image and paint data showing the background image with each other, and stores the associated paint data in the memory as the history information.

Preferably, the processor associates draw data showing the hand-drawn image and paint data showing the background image with each other, and stores the associated draw data and paint data in the memory as the history information.

According to another aspect of the present invention, a display method in a computer including a memory, a touch panel and a processor is provided. The display method includes the steps of: causing, by the processor, the touch panel to display a background image; receiving, by the processor, input of a hand-drawn image through the touch panel; causing , by the processor, the touch panel to display the background image and the hand-drawn image to overlap each other; receiving, by the processor, input of an instruction to delete the hand-drawn image superimposed on the background image; storing, by the processor, in the memory as history information, the background image and the hand-drawn image having been displayed on the touch panel when the instruction is input; and causing, by the processor, the touch panel to display the background image and the hand-drawn image to overlap each other based on the history information.

According to still another aspect of the present invention, a display program for causing a computer including a memory, a touch panel and a processor to display an image is provided. The display program causes the processor to execute the steps of: causing the touch panel to display a background image; receiving input of a hand-drawn image through the touch panel; causing the touch panel to display the background image and the hand-drawn image to overlap each other; receiving input of an instruction to delete the hand-drawn image superimposed on the background image; storing, in the memory as history information, the background image and the hand-drawn image having been displayed on the touch panel when the instruction is input; and causing the touch panel to display the background image and the hand-drawn image to overlap each other based on the history information.

### ADVANTAGEOUS EFFECTS OF INVENTION

As described above, according to the present invention, an electronic device that enables browsing of a hand-drawn image input in the past together with a corresponding moving image, a display method, and a computer-readable recording medium storing a display program are provided.

### BRIEF DESCRIPTION OF DRAWINGS

FIG. 1 is a schematic diagram showing an example of a network system according to the present embodiment.

FIG. 2 is a sequence diagram showing an outline of the operation in the network system according to the present embodiment.

FIG. 3 is a representation of transition of a display screen in a display device in accordance with the outline of the operation according to the present embodiment.

FIG. 4 is a representation of the outline of the operation related to transmission and reception of a hand-drawn image according to the present embodiment.

FIG. 5 is a representation of an appearance of a mobile phone according to the present embodiment.

FIG. 6 is a block diagram showing the hardware configuration of the mobile phone according to the present embodiment.

FIG. 7 is a representation of various kinds of data structures constituting a memory according to the present embodiment.

FIG. 8 is a block diagram showing the hardware configuration of a chat server according to the present embodiment.

FIG. 9 is a representation of the data structure of a room management table stored in a memory or a fixed disk of the chat server according to the present embodiment.

FIG. 10 is a flowchart showing a procedure of a P2P communication process in the network system according to the present embodiment.

FIG. 11 is a representation of the data structure of transmission data according to the present embodiment.

FIG. 12 is a flowchart showing a procedure of an input process in the mobile phone according to the present embodiment.

FIG. 13 is a flowchart showing a procedure of a pen information setting process in the mobile phone according to the present embodiment.

FIG. 14 is a flowchart showing a procedure of a hand-drawing process in the mobile phone according to the present embodiment.

FIG. 15 is a representation of data showing a hand-drawn image according to the present embodiment.

FIG. 16 is a flowchart showing a procedure of a display process in the mobile phone according to the present embodiment.

FIG. 17 is a flowchart showing a procedure of an application example of the display process in the mobile phone according to the present embodiment.

FIG. 18 is a flowchart showing a procedure of a hand-drawn image display process in a mobile phone according to the first embodiment.

FIG. 19 is a flowchart showing a procedure of the first history generating process in the mobile phone according to the first embodiment.

FIG. 20 is a representation of history data according to the first history generating process.

FIG. 21 is a diagram showing the data structure of history information according to the first history generating process.

FIG. 22 is a flowchart showing a procedure of the second history generating process in the mobile phone according to the first embodiment.

FIG. 23 is a representation of history data according to the second history generating process.

FIG. 24 is a diagram showing the data structure of history information according to the second history generating process.

FIG. 25 is a flowchart showing a procedure of the third history generating process in the mobile phone according to the first embodiment.

FIG. 26 is a representation of history data according to the third history generating process.

FIG. 27 is a diagram showing the data structure of history information according to the third history generating process.

FIG. 28 is a flowchart showing a procedure of a hand-drawn image display process in a mobile phone according to the second embodiment.

FIG. 29 is a flowchart showing a procedure of the first history generating process in the mobile phone according to the second embodiment.

FIG. 30 is a flowchart showing a procedure of the second history generating process in the mobile phone according to the second embodiment.

FIG. 31 is a flowchart showing a procedure of the third history generating process in the mobile phone according to the second embodiment.

### DESCRIPTION OF EMBODIMENTS

The embodiments of the present invention will be hereinafter described with reference to the accompanying drawings. In the following description, the same components are designated by the same reference characters. Names and functions thereof are also the same. Accordingly, the detailed description thereof will not be repeated.

Furthermore, hereinafter, a mobile phone 100 will be referred to as a representative example of a “display device”. However, the display device may be an information device having a display, such as a personal computer, a car navigation device (a satellite navigation system), a personal navigation device (PND), a personal data assistance (PDA), a game machine, an electronic dictionary, and an electronic BOOK. It is preferable that the display device may be an information communication device connectable to a network and capable of transmitting and receiving data to and from another device.

### First Embodiment

### <General Configuration of Network System 1>

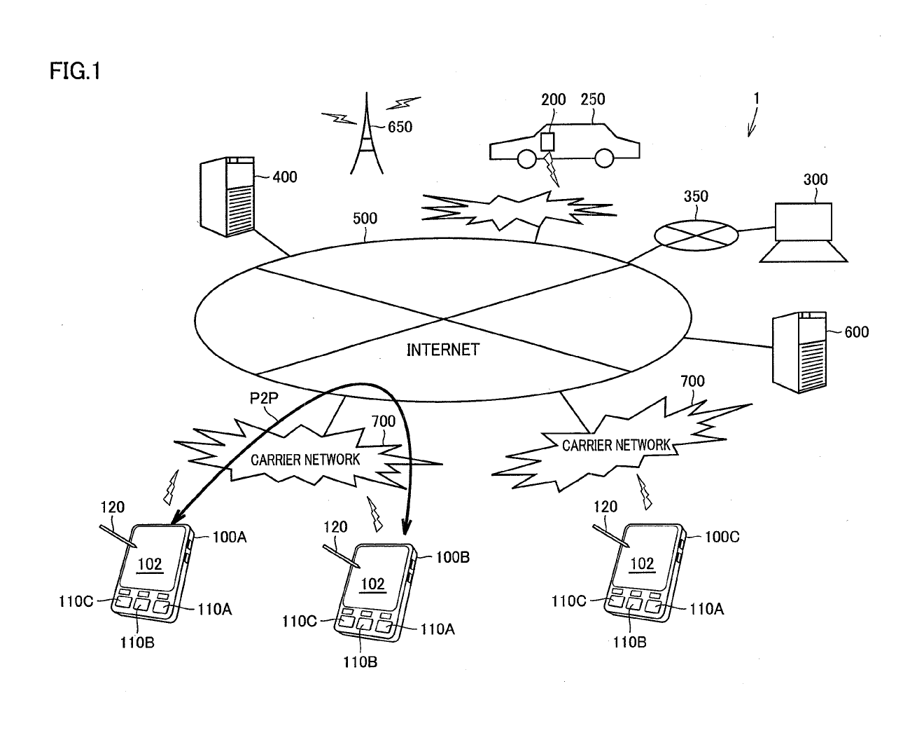

The general configuration of a network system 1 according to the present embodiment will be first described. FIG. 1 is a schematic diagram showing an example of network system 1 according to the present embodiment. As shown in FIG. 1, network system 1 includes mobile phones 100A, 100B and 100C, a chat server (first server device) 400, a contents server (second server device) 600, a broadcasting station (an antenna for television broadcasting) 650, an Internet (first network) 500, and a carrier network (second network) 700. Furthermore, network system 1 according to the present embodiment includes a car navigation device 200 mounted in a vehicle 250, and a personal computer (PC) 300.

To facilitate description, hereinafter described will be network system 1 according to the present embodiment including first mobile phone 100A, second mobile phone 100B and third mobile phone 100C. Furthermore, in describing a configuration, a function or the like common to mobile phones 100A, 100B and 100C, the mobile phones will also collectively be referred to as mobile phone 100. Furthermore, in describing a configuration, a function or the like common to mobile phones 100A, 100B and 100C, car navigation device 200, and personal computer 300, they will also collectively be referred to as a display device. Mobile phone 100 is configured to be connectable to carrier network 700. Car navigation device 200 is configured to be connectable to Internet 500. Personal computer 300 is configured to be connectable through a local area network (LAN) 350, a wide area network (WAN) or the like to Internet 500. Chat server 400 is configured to be connectable to Internet 500. Contents server 600 is configured to be connectable to Internet 500.

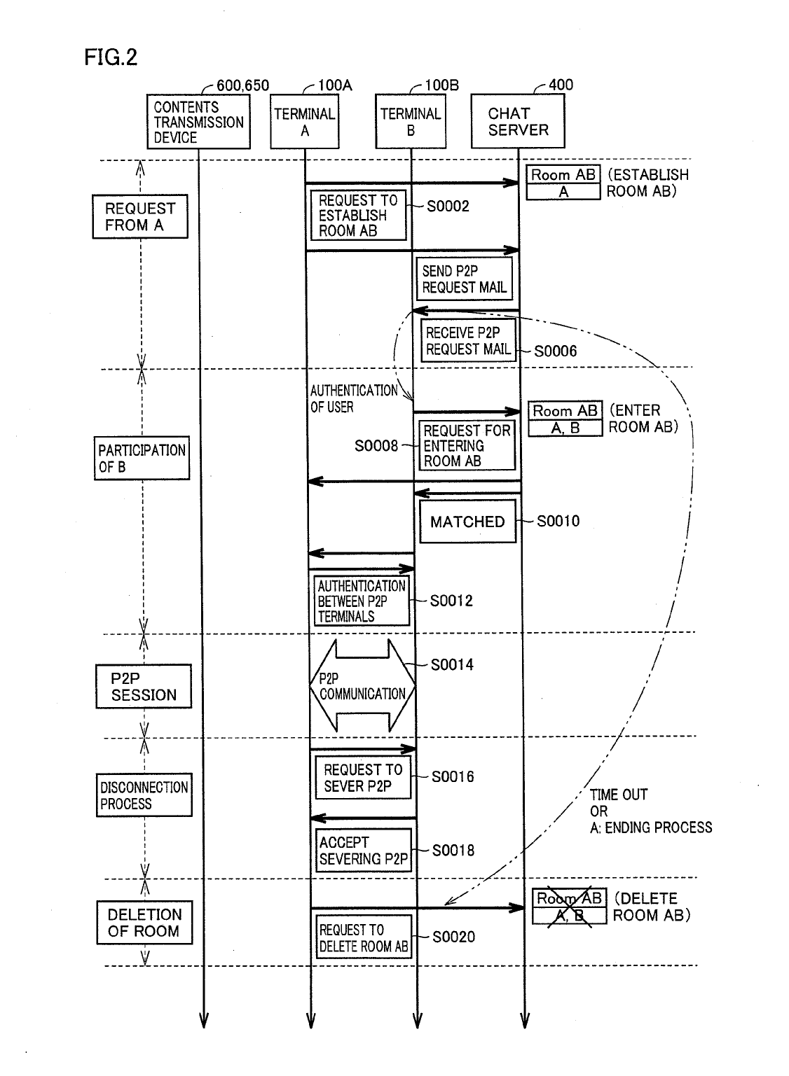

More specifically, first mobile phone 100A, second mobile phone 100B, third mobile phone 100C, car navigation device 200, and personal computer 300 are interconnectable via Internet 500, carrier network 700 and mail transmission server (chat server 400 in FIG. 2), and also capable of mutually transmitting and receiving data. In the present embodiment, mobile phone 100, car navigation device 200 and personal computer 300 are assigned identification information such as a mail address, an Internet protocol (IP) address or the like for identifying their own terminals. Mobile phone 100, car navigation device 200 and personal computer 300 can each store identification information of other display devices in its internal storage medium. Based on that identification information, mobile phone 100, car navigation device 200 and personal computer 300 can each transmit/receive data to/from these other display devices via carrier network 700, Internet 500 and/or the like.

Mobile phone 100, car navigation device 200 and personal computer 300 according to the present embodiment can use IP addresses assigned to other display devices to each transmit/receive data to/from these other display devices without depending on servers 400 and 600. That is, mobile phone 100, car navigation device 200 and personal computer 300 included in network system 1 according to the present embodiment can constitute a so-called peer-to-peer (P2P) type network.

Herein, when each display device accesses chat server 400, that is, when each display device accesses the Internet, the display device is assigned an IP address by chat server 400 or another server device not shown. The IP address is assigned in a process known in detail, description of which will not be repeated here.

Broadcasting station 650 according to the present embodiment transmits digital terrestrial television broadcasting. For example, broadcasting station 650 transmits one-segment broadcasting. Mobile phone 100, car navigation device 200 and personal computer 300 receive one-segment broadcasting. Users of mobile phone 100, car navigation device 200 and personal computer 300 can view a TV program (moving image contents) and the like received from broadcasting station 650.

Mobile phone 100, car navigation device 200 and personal computer 300 substantially simultaneously receive an Internet TV and/or other moving image contents from contents server 600 via the Internet 500. Users of mobile phone 100, car navigation device 200 and personal computer 300 can view moving image contents from contents server 600.

### <General Outline of Operation of Network System 1>

Network system 1 according to the present embodiment generally operates, as will be described hereinafter. FIG. 2 is a sequence diagram showing an outline of an operation in network system 1 according to the present embodiment. In FIG. 2, contents server 600 and broadcasting station 650 in FIG. 1 are collectively referred to as a contents transmission device.

As shown in FIGS. 1 and 2, the display devices according to the present embodiment first need to exchange (or obtain) their IP addresses mutually in order to perform P2P type data communication. Upon obtaining an IP address, each display device performs P2P type data communication to transmit a message, an attached file, and/or the like to other display devices.

Hereinafter, will be described how each display device transmits/receives each other's identification information (e.g., IP address), a message, an attached file and/or the like to/from each other through a chat room generated in chat server 400, and also will be described how first mobile phone 100A generates a new chat room in chat server 400 and invites second mobile phone 100B to the chat room.

Initially, first mobile phone 100A (indicated in FIG. 2 as a terminal A) requests IP registration (or login) from chat server 400 (step S0002). First mobile phone 100A may obtain an IP address simultaneously, or may obtain it in advance. More specifically, first mobile phone 100A transmits the mail and IP addresses of first mobile phone 100A, the mail address of second mobile phone 100B, and a message requesting generation of a new chat room to chat server 400 via carrier network 700, the mail transmission server (chat server 400) and Internet 500.

In response to the request, chat server 400 associates the mail address of first mobile phone 100A with the IP address thereof and thus stores the addresses. Chat server 400 generates a room name based on the mail address of first mobile phone 100A and the mail address of second mobile phone 100B, and generates a chat room with that room name. Chat server 400 may notify first mobile phone 100A that the chat room has been generated. Chat server 400 associates the room name with the current participant display devices' IP addresses and thus stores them.

Alternatively, based on the mail address of first mobile phone 100A and the mail address of second mobile phone 100B, first mobile phone 100A generates a room name for a new chat room, and transmits that room name to chat server 400. Chat server 400 generates a new chat room based on the room name.

First mobile phone 100A transmits, to second mobile phone 100B, a P2P participation request mail indicating that the new chat room has been generated, i.e., an invitation to the chat room (step S0004, step S0006). More specifically, first mobile phone 100A transmits the P2P participation request mail to second mobile phone 100B via carrier network 700, the mail transmission server (chat server 400) and Internet 500 (step S0004, step S0006). It is to be noted that chat server 400 may also serve as contents server 600.

Upon receipt of the P2P participation request mail (step S0006), second mobile phone 100B generates a room name based on the mail address of first mobile phone 100A and the mail address of second mobile phone 100B, and transmits to chat server 400 the mail and IP addresses of second mobile phone 100B and a message indicating that second mobile phone 100B will enter the chat room having the room name (step S0008). Second mobile phone 100B may obtain an IP address simultaneously, or may obtain an IP address in advance and then access chat server 400. Chat server 400 receives the message and determines whether or not the mail address of second mobile phone 100B corresponds to the room name. Then, chat server 400 associates the mail address of second mobile phone 100B with the IP address thereof and stores them. Then, chat server 400 signals to first mobile phone 100A that second mobile phone 100B has entered the chat room, and chat server 400 transmits the IP address of second mobile phone 100B to first mobile phone 100A (step

S0010). Simultaneously, chat server 400 signals to second mobile phone 100B that chat server 400 has accepted entrance of second mobile phone 100B into the chat room, and chat server 400 transmits the IP address of first mobile phone 100A to second mobile phone 100B.

First mobile phone 100A and second mobile phone 100B obtain their partners' mail and IP addresses and authenticate each other (step S0012). Once the authentication has been completed, first mobile phone 100A and second mobile phone 100B start P2P communication (chat communication) (step S0014). The outline of the operation during the P2P communication will be described later.

First mobile phone 100A transmits to second mobile phone 100B a message indicating that P2P communication is severed (step S0016). Second mobile phone 100B transmits to first mobile phone 100A a message indicating that second mobile phone 100B has accepted the request to sever the communication (step S0018). First mobile phone 100A transmits a request to chat server 400 to delete the chat room (step S0020), and chat server 400 deletes the chat room.

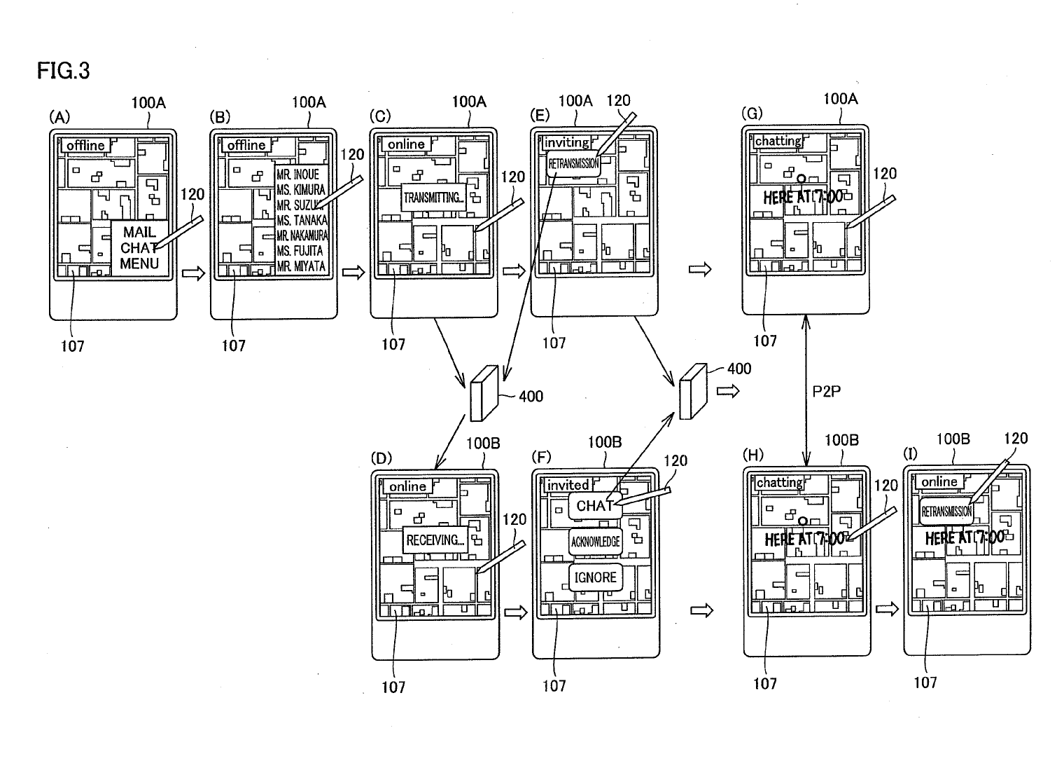

Hereinafter reference will be made to FIGS. 2 and 3 to more specifically describe how network system 1 according to the present embodiment generally operates. FIG. 3 is a representation of transition of display screens in display devices in accordance with the outline of the operation according to the present embodiment. In the following description, first mobile phone 100A and second mobile phone 100B transmit and receive an input hand-drawn image to and from each other while displaying contents obtained from broadcasting station 650 or contents server 600 as a background.

As shown in FIG. 3(A), initially, first mobile phone 100A receives and displays contents such as a TV program. When the user of first mobile phone 100A desires to have a chat with the user of second mobile phone 100B while viewing the TV program, first mobile phone 100A receives an instruction for starting the chat. As shown in FIG. 3(B), first mobile phone 100A receives an instruction for selecting a user who is to be a chat partner.

In this case, as shown in FIG. 3(C), first mobile phone 100A transmits information for identifying the TV program via the mail transmission server (chat server 400) to second mobile phone 100B (step S0004). As shown in FIG. 3(D), second mobile phone 100B receives the information from first mobile phone 100A (step S0006). Second mobile phone 100B receives and displays the TV program based on that information.

It is to be noted that first mobile phone 100A and second mobile phone 100B may both receive moving image contents such as a TV program from broadcasting station 650 or contents server 600 after starting the P2P communication, i.e., during the P2P communication.

As shown in FIG. 3(E), first mobile phone 100A can repeat transmission of the mail without performing the P2P communication with second mobile phone 100B. Once the mail has been transmitted, first mobile phone 100A registers its own IP address with chat server 400 and requests chat server 400 to generate a new chat room based on the mail address of first mobile phone 100A and the mail address of second mobile phone 100B (step S0002).

As shown in FIG. 3(F), second mobile phone 100B receives an instruction to start the chat, and transmits to chat server 400 a room name, a message indicating that second mobile phone 100B will enter the chat room, and its own IP address (step S0008). First mobile phone 100A obtains the IP address of second mobile phone 100B while second mobile phone 100B obtains the IP address of first mobile phone 100A (step S0010), and they authenticate each other (step S0012).

Thus, as shown in FIGS. 3(G) and 3(H), first mobile phone 100A and second mobile phone 100B can perform P2P communication (hand-drawing chat communication) (step S0014). That is, first mobile phone 100A and second mobile phone 100B according to the present embodiment transmit/receive data showing an input hand-drawn image to/from each other during reproduction of moving image contents.

More specifically, in the present embodiment, first mobile phone 100A receives input of the hand-drawn image from the user and displays the hand-drawn image on the moving image contents. First mobile phone 100A transmits the hand-drawn image to second mobile phone 100B. Second mobile phone 100B displays the hand-drawn image on the moving image contents based on the hand-drawn image from first mobile phone 100A.

In contrast, second mobile phone 100B also receives input of the hand-drawn image from the user and displays the hand-drawn image on the moving image contents. Second mobile phone 100B transmits the hand-drawn image to first mobile phone 100A. Second mobile phone 100B displays the hand-drawn image on the moving image contents based on the hand-drawn image from first mobile phone 100A.

Then, as will be describe later, in network system 1 according to the present embodiment, first mobile phone 100A and second mobile phone 100B store an image being displayed on a display 107 as history information when either first mobile phone 100A or second mobile phone 100B receives an instruction to clear a hand-drawn image from the user. More specifically, when either first mobile phone 100A or second mobile phone 100B receives the clear instruction, both of them store the frame (still image) of moving image contents and the hand-drawn image being displayed on display 107, and delete the hand-drawn image being displayed from display 107. In network system 1 according to the present embodiment, when the scene of moving image contents is changed, first mobile phone 100A and second mobile phone 100B store as history information an image having been displayed on display 107 immediately before the scene is changed. More specifically, first mobile phone 100A and second mobile phone 100B store the frame of moving image contents and the hand-drawn image having been displayed on display 107 immediately before the scene is changed, and delete the hand-drawn image being displayed from display 107.

After first mobile phone 100A severs the P2P communication (step S0016, step S0018), second mobile phone 100B can transmit mail to first mobile phone 100A or the like, as shown in FIG. 3(I). It is to be noted that the P2P communication can also be performed by a TCP/IP communication method while mail can also be transmitted/received by an HTTP communication method. In other words, mail can also be transmitted/received during the P2P communication.

<Outline of Operation related to Transmission/Reception of Hand-drawn Image in Network System 1>

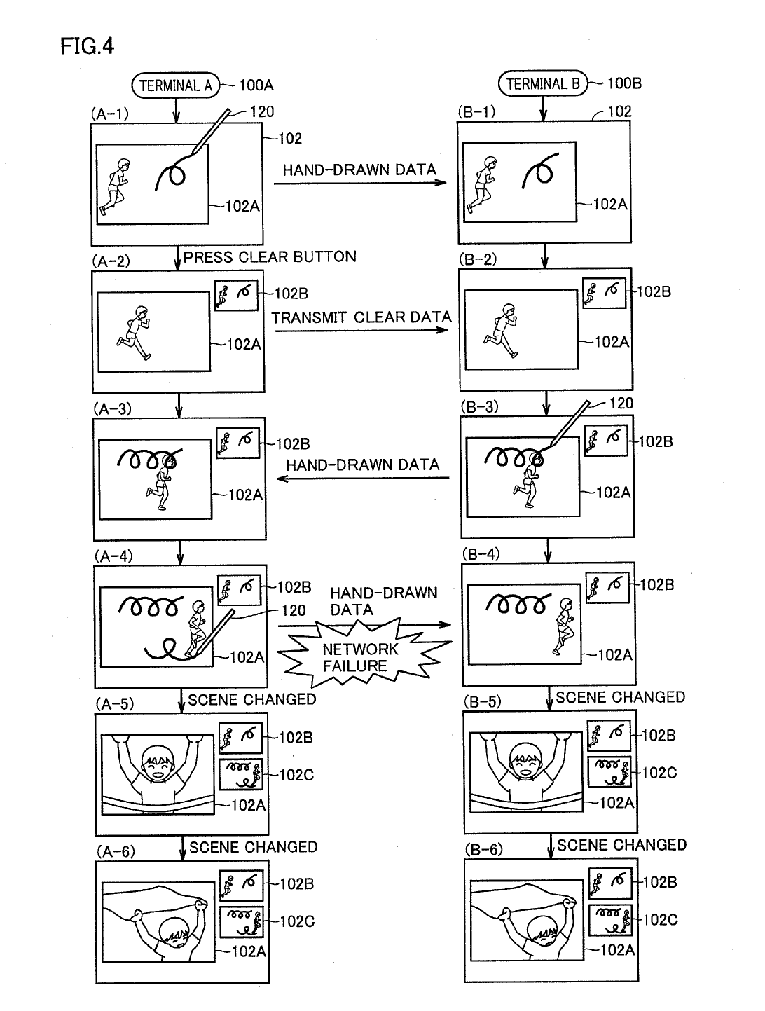

Next, the outline of the operation related to transmission/reception of the hand-drawn image, that is, the outline of the operation of network system 1 during chart communication, will be described in greater detail. FIG. 4 is a representation of the outline of the operation related to transmission/reception of a hand-drawn image. In the following description, first mobile phone 100A and second mobile phone 100B performs chat communication.

Referring to FIGS. 4(A-1) and (B-1), first mobile phone 100A and second mobile phone 100B receive the same moving image contents (e.g., a TV program) from broadcasting station 650 or contents server 600, and display the moving image contents in a first region 102A. At this time, third mobile phone 100C not participated in the chat communication may also receive and display the same moving image contents.

When the user of first mobile phone 100A inputs a hand-drawn image in first region 102A of a touch panel 102, touch panel 102 causes the input hand-drawn image to be displayed in first region 102A. That is, first mobile phone 100A causes the hand-drawn image to be displayed to overlap the moving image contents. First mobile phone 100A sequentially transmits data related to the hand-drawn image to second mobile phone 100B.

Second mobile phone 100B receives the hand-drawn image from first mobile phone 100A, and causes the hand-drawn image to be displayed in first region 102A of touch panel 102. That is, while reproducing the same moving image, first mobile phone 100A and second mobile phone 100B cause the same hand-drawn image to be displayed on this moving image.

Referring to FIG. 4(A-2), the user of first mobile phone 100A presses a clear button (a button for resetting a hand-drawn image) via touch panel 102. First mobile phone 100A transmits to second mobile phone 100B a message that the clear button has been pressed.

Touch panel 102 causes the hand-drawn image having been input so far to be hidden. More specifically, touch panel 102 causes only the hand-drawn image to be deleted from first region 102A. First mobile phone 100A stores as history information the hand-drawn image and the frame of moving image having been displayed when the clear button is pressed.

In the present embodiment, based on the history information, first mobile phone 100A causes the hand-drawn image and the frame of moving image having been displayed when the clear button is pressed to be displayed to overlap each other in a second region 102B of touch panel 102. At this time, first mobile phone 100A continues reproducing the moving image contents in first region 102A of touch panel 102.

Referring to FIG. 4(B-2), second mobile phone 100B receives that message, and hides the hand-drawn image having been input so far. More specifically, touch panel 102 causes only the hand-drawn image to be deleted from first region 102A. Second mobile phone 100B stores as history information the hand-drawn image and the frame of moving image having been displayed when the clear button of first mobile phone 100A is pressed (or when a message is received).

Based on the history information, second mobile phone 100B displays, in second region 102B of touch panel 102, the hand-drawn image and the frame of moving image having been displayed when the clear button is pressed. At this time, second mobile phone 100B continues reproducing the moving image contents in first region 102A of touch panel 102.

Referring to FIG. 4(B-3), when the user of second mobile phone 100B inputs a hand-drawn image in first region 102A of touch panel 102, touch panel 102 causes the input hand-drawn image to be displayed in first region 102A. Second mobile phone 100B sequentially transmits data on the hand-drawn image to second mobile phone 100A. Referring to FIG. 4(A-3), first mobile phone 100A receives the hand-drawn image from second mobile phone 100B, and displays the hand-drawn image in first region 102A of touch panel 102.

Referring to FIG. 4(A-4), when the user of first mobile phone 100A inputs a hand-drawn image to first region 102A of touch panel 102, touch panel 102 displays the input hand-drawn image in first region 102A. First mobile phone 100A sequentially transmits data related to the hand-drawn image to second mobile phone 100B.

In this manner, first mobile phone 100A and second mobile phone 100B both display the same hand-drawn image in first region 102A while reproducing the same moving image in first region 102A. It is to be noted, however, FIG. 4(B-4) shows a representation of the case where a network failure occurs, as will be described below.

First mobile phone 100A and second mobile phone 100B according to the present embodiment always determine whether or not the scene of moving image contents being displayed has been changed. For example, first mobile phone 100A and second mobile phone 100B determine whether or not the scene has been changed by determining whether or not the scene number has been changed or whether or not the amount of changes in image is greater than or equal to a predetermined value.

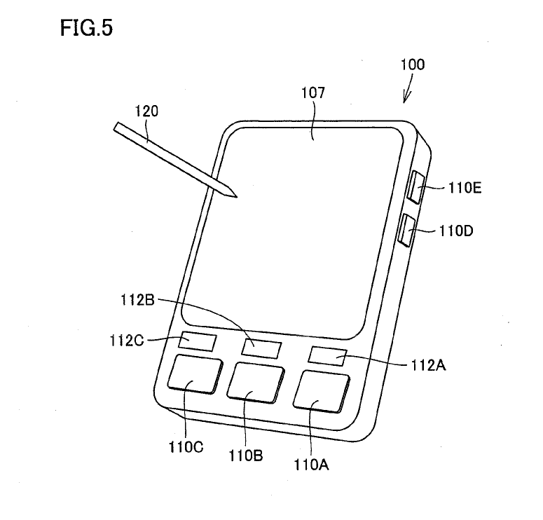

Referring to FIGS. 4(A-5) and (B-5), once the scene of moving image contents has been changed, touch panel 102 of each of first mobile phone 100A and second mobile phone 100B causes the hand-drawn image having been input so far to be hidden.

First mobile phone 100A and second mobile phone 100B store as history information the hand-drawn image and the frame of moving image (the last still image of the scene) having been displayed immediately before the scene is changed.

In the present embodiment, based on the history information, first mobile phone 100A and second mobile phone 100B display the hand-drawn image and the frame of moving image having been displayed immediately before the scene is changed to overlap each other in a third region 102C of touch panel 102. At this time, first mobile phone 100A and second mobile phone 100B continuously reproduce the moving image contents in first region 102A of touch panel 102.

Similarly, referring to FIGS. 4(A-6) and (B-6), once the scene of moving image contents has been further changed, touch panel 102 of each of first mobile phone 100A and second mobile phone 100B causes the hand-drawn image having been input so far to be hidden. Here, since no other hand-drawn image has been input before the scene is changed, it is not necessary to hide the hand-drawn image. That is, in the present embodiment, in the case where a hand-drawn image is not displayed in first region 102A (on a moving image being reproduced) when the scene is changed, first mobile phone 100A and second mobile phone 100B do not need to store the hand-drawn image and the frame of moving image (the last frame of the scene).

In another embodiment, in the case where a hand-drawn image is not displayed in first region 102A (on a moving image being reproduced) when the scene is changed, first mobile phone 100A and second mobile phone 100B can store the moving image frame alone as history information.

Referring to FIGS. 4(A-4) and (B-4), in the present embodiment, first mobile phone 100A and second mobile phone 100B can store the same history information even if a failure occurs in the network between first mobile phone 100A and second mobile phone 100B. That is, even if a failure occurs in the network, first mobile phone 100A and second mobile phone 100B can both associate an input hand-drawn image with a frame of moving image contents corresponding to the input time, and store the associated image and frame.

As will be described later, first mobile phone 100A and second mobile phone 100B transmit the input hand-drawn image together with information indicating the input timing. Here, the input timing can include the time when the hand-drawn image is input, the scene number or frame number of a moving image being displayed when the hand-drawn image is input, and the like.

Consequently, the receiving side of the hand-drawn image (second mobile phone 100B in FIG. 4) can associate the hand-drawn image with a corresponding frame of moving image contents, and store the associated image and frame as history information, and/or overwrite and store the history information. As a result, as shown in FIG. 4(B-5), the same history image can be displayed in third region 102C of first mobile phone 100A and third region 102C of second mobile phone 100B.

As described above, in network system 1 according to the present embodiment, first mobile phone 100A and second mobile phone 100B each associate a hand-drawn image with a frame of moving image (still image data) being displayed when that hand-drawn image is input, and store the associated image and frame as history information. Therefore, by referring to this history information, first mobile phone 100A and second mobile phone 100B can display the hand-drawn image together with the frame of moving image being displayed when this hand-drawn image is input.

Particularly, in network system 1 according to the present embodiment, first mobile phone 100A and second mobile phone 100B each associate a hand-drawn image with a frame of moving image being displayed when an instruction to delete (reset) this hand-drawn image is input, and each store the associated image and frame as history information. Therefore, by referring to this history information, first mobile phone 100A and second mobile phone 100B can display the hand-drawn image together with the frame of moving image being displayed when the instruction to delete (reset) this hand-drawn image is input.

Alternatively, in network system 1 according to the present embodiment, in the case where the scene of moving image is changed when the hand-drawn image is being displayed, first mobile phone 100A and second mobile phone 100B each associate this hand-drawn image with the frame of moving image immediately before the scene is changed, and store the associated image and frame as history information. Therefore, by referring to this history information, first mobile phone 100A and second mobile phone 100B can display the hand-drawn image together with the frame of moving image immediately before the scene is changed.

It is noted that, in the present embodiment, a moving image being reproduced and a hand-drawn image are displayed to overlap each other in first region 102A of touch panel 102, while the frame and the hand-drawn image are displayed to overlap each other in second region 102B (102C) of touch panel 102. That is, a moving image being reproduced and a history image are simultaneously displayed side by side on touch panel 102.

However, the display device may switch between the first mode and the second mode in response to a switching instruction from the user. That is, in the first mode, the display device may display a moving image being reproduced and a hand-drawn image to overlap each other on touch panel 102. In the second mode, the display device may display a frame and a hand-drawn image to overlap each other on touch panel 102.

As described above, in the display device according to the present embodiment, the difference between a screen at the time of a hand-drawn image is input (first region 102A) and a screen for displaying the hand-drawn image as a history (second region 102B) becomes small. As a result, the user's intention when he/she inputs the hand-drawn image is to be transmitted more appropriately to this user or the user's communication partner. The configuration of network system 1 for implementing such a function will be hereinafter described in detail.

### <Hardware Configuration of Mobile Phone 100>

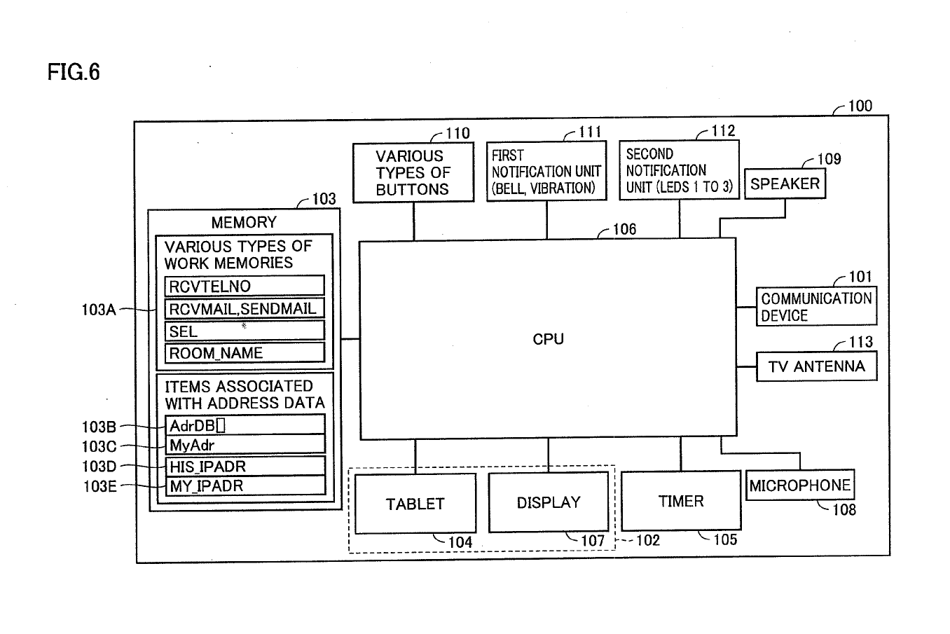

The hardware configuration of mobile phone 100 according to the present embodiment will be described hereinafter. FIG. 5 is a representation of an appearance of mobile phone 100 according to the present embodiment. FIG. 6 is a block diagram showing the hardware configuration of mobile phone 100 according to the present embodiment.

As shown in FIGS. 5 and 6, mobile phone 100 according to the present embodiment includes a communication device 101 transmitting/receiving data to/from an external network, a TV antenna 113 for receiving television broadcasting, a memory 103 storing a program and various of types of databases, a CPU (Central Processing Unit) 106, a display 107, a microphone 108 receiving external sound, a speaker 109 outputting sound, various types of buttons 110 receiving various pieces of information input, a first notification unit 111 outputting audible notification indicating that externally communicated data, a call signal and/or the like have/has been received, and a second notification unit 112 displaying notification indicating that externally communicated data, a call signal and/or the like have/has been received.

Display 107 according to the present embodiment implements touch panel 102 configured of a liquid crystal panel, a CRT or the like. Specifically, mobile phone 100 according to the present embodiment is provided with a pen tablet 104 over (or at the front side of) display 107. This allows the user to use a stylus pen 120 or the like to hand-draw and input graphical information or the like through pen tablet 104 to CPU 106.

In addition, the user can provide a hand-drawn input also by the following methods. Specifically, a special pen that outputs infrared rays and/or acoustic waves is utilized, thereby allowing the movement of the pen to be identified by a receiving unit receiving the infrared rays and/or acoustic waves emitted from the pen. In this case, by connecting this receiving unit to a device storing the movement path, CPU 106 can receive the movement path output from this device as hand-drawn input.

Alternatively, the user can also write a hand-drawn image onto an electrostatic panel using a finger or a pen for an electrostatic application.

In this way, display 107 (touch panel 102) displays an image, a text and/or the like based on data output by CPU 106. For example, display 107 displays moving image contents received via communication device 101 or TV antenna 113. Based on a hand-drawn image received via tablet 104 or a hand-drawn image received via communication device 101, display 107 superimposes and displays a hand-drawn image on the moving image contents.

Various types of buttons 110 receive information from a user, for example, by operating a key for input. For example, various types of buttons 110 include a TEL button 110A for receiving a telephone call or making a telephone call, a mail button 110B for receiving mail or sending mail, a P2P button 110C for receiving P2P communication or sending P2P communication, an address book button 110D used to access address book data, and an end button 110E for terminating a variety of types of processes. That is, when P2P participation request mail is received via communication device 101, various types of buttons 110 selectively receive an instruction input by a user to enter a chat room, an instruction to display the mail's content(s), and the like.

Various buttons 110 may also include a button for receiving an instruction to start a hand-drawing input, namely, a button for receiving first input. Various buttons 110 may also include a button for receiving an instruction to terminate hand-drawing input, namely, a button for receiving the second input.

First notification unit 111 outputs a ringer tone through speaker 109 or the like. Alternatively, first notification unit 111 has a vibration function. When an incoming call, mail, P2P participation request mail and/or the like are/is received, first notification unit 111 outputs sound, vibrates mobile phone 100, and/or the like.

Second notification unit 112 includes a light emitting diode (LED) 112A for TEL, an LED 112B for mail, and an LED 112C for P2P. LED 112A for TEL flashes on/off when a call is received. LED 112B for mail flashes on/off when mail is received. LED 112C for P2P flashes on/off when P2P communication is received.

CPU 106 controls each unit of mobile phone 100. For example, CPU 106 receives a variety of types of instructions from a user via touch panel 102 and/or various types of buttons 110, executes a process corresponding to that instruction and transmits/receives data to/from an external display device via communication device 101, a network and/or the like.

Communication device 101 receives communication data from CPU 106 and converts the data into a communication signal, and sends the signal externally. Communication device 101 converts a communication signal externally received into communication data, and inputs the communication data to CPU 106.

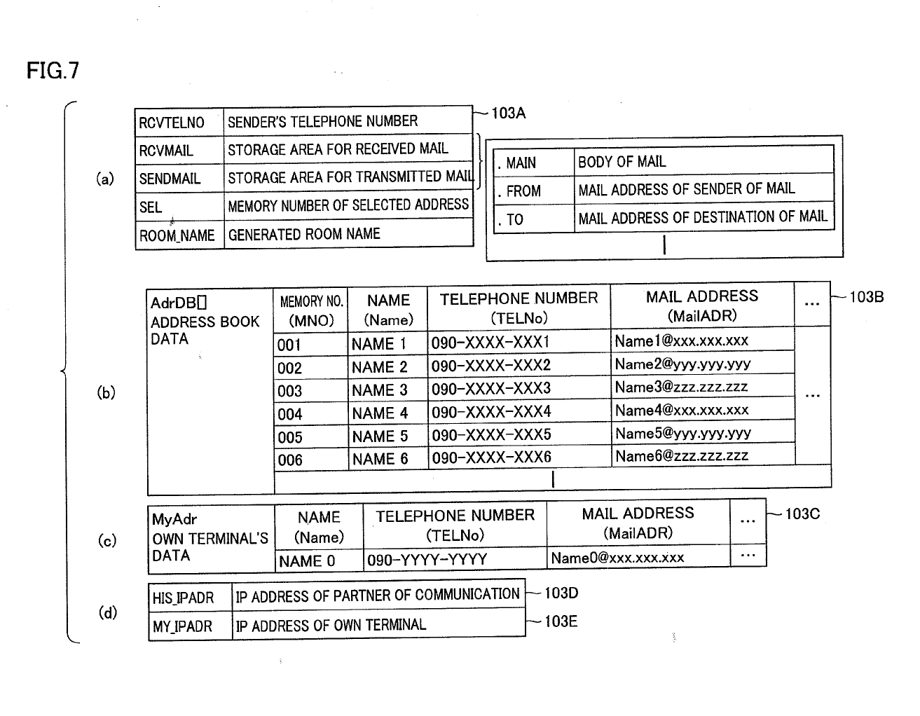

Memory 103 is implemented as: random access memory (RAM) functioning as working memory; read only memory (ROM) storing a control program or the like; a hard disk storing image data or the like; and the like. FIG. 7(a) represents a data structure of a variety of types of work memory 103A configuring memory 103. FIG. 7(b) represents address book data 103B stored in memory 103. FIG. 7(c) represents own terminal's data 103C stored in memory 103. FIG. 7(d) represents own terminal's IP address data 103D and another terminal's IP address data 103E stored in memory 103.

As shown in FIG. 7(a), work memory 103A in memory 103 includes a RCVTELNO area storing an originator's telephone number, a RCVMAIL area storing information on received mail, a SENDMAIL area storing information on sent mail, an SEL area storing the memory number of an address selected, a ROOMNAME area storing a room name generated, and/or the like. It is to be noted that work memory 103A does not need to store a telephone number. The information on received mail includes the body of mail stored in a MAIN area, and a mail address of a sender of mail stored in the RCVMAIL area at a FROM area. The information on sent mail includes the body of mail stored in the MAIN area, and a mail address of a destination of mail stored in the RCVMAIL area at a TO area.

As shown in FIG. 7(b), address book data 103B associates a memory number for each destination (or for each of other display devices). Address book data 103B associates a name, a telephone number, a mail address, and the like with one another for each destination, and thus stores them.

As shown in FIG. 7(c), own terminal's data 103C stores the name of the own terminal's user, the own terminal's telephone number, the own terminal's mail address and the like.

As shown in FIG. 7(d), the own terminal's IP address data 103D contains the own terminal's IP address. Another terminal's IP address data 103E contains another terminal's IP address.

By utilizing the data shown in FIG. 7, each mobile phone 100 according to the present embodiment can transmit and receive data to and from other display devices by the method as described above (see FIGS. 1 to 3).

### <Hardware Configuration of Chat Server 400 and Contents Server 600>

The present embodiment provides chat server 400 and contents server 600 having a hardware configuration, as will be described hereinafter. The hardware configuration of chat server 400 will be hereinafter first described.

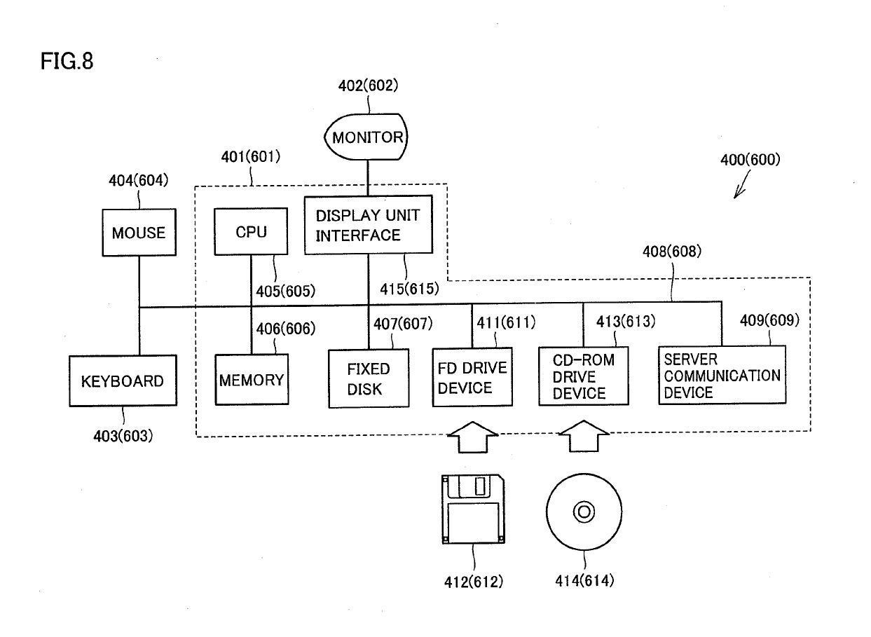

FIG. 8 is a block diagram showing the hardware configuration of chat server 400 according to the present embodiment. As shown in FIG. 8, chat server 400 according to the present embodiment includes a CPU 405, a memory 406, a fixed disk 407, and a server communication device 409 interconnected by an internal bus 408.

Memory 406 stores a variety of types of information, and for example, temporarily stores data required for execution of a program in CPU 405. Fixed disk 407 stores a program executed by CPU 405, a database, and the like. CPU 405, which controls each element of chat server 400, is a device performing a variety of types of operations.

Server communication device 409 receives data output from CPU 405, converts the data into an electrical signal, and externally transmits the signal. Server communication device 409 also converts an externally received electrical signal into data for input to CPU 405. More specifically, server communication device 409 receives data from CPU 405 and transmits the data via Internet 500, carrier network 700, and/or the like to a device connectable to a network, such as mobile phone 100, car navigation device 200, personal computer 300, a game machine, an electronic dictionary, an electronic BOOK, and the like. Server communication device 409 inputs, to CPU 405, data received via Internet 500, carrier network 700 and/or the like from a device connectable to a network, such as mobile phone 100, car navigation device 200, personal computer 300, a game machine, an electronic dictionary, an electronic BOOK, and the like.

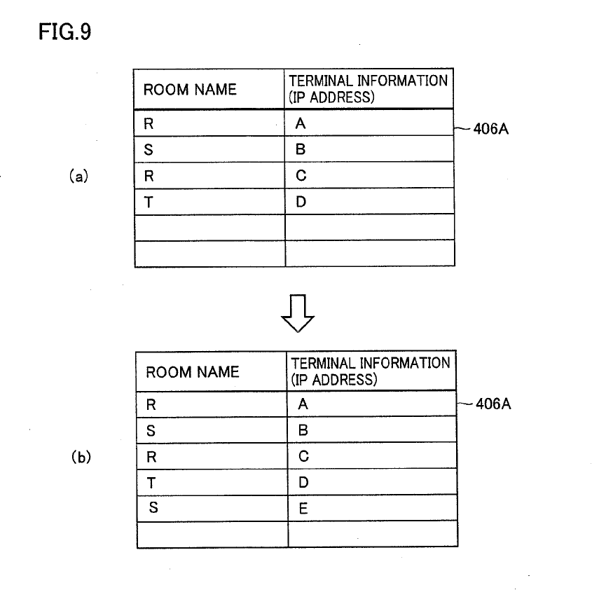

The data stored in memory 406 or fixed disk 407 will be hereinafter described. FIG. 9(a) is a first representation of a data structure of a room management table 406A stored in chat server 400 at memory 406 or fixed disk 407. FIG. 9(b) is a second representation of the data structure of room management table 406A stored in chat server 400 at memory 406 or fixed disk 407.

As shown in FIGS. 9(a) and 9(b), room management table 406A associates a room name with an IP address and thus stores them. For example, at a point in time, as shown in FIG. 9(a), chat rooms having room names R, S and T, respectively, are generated in chat server 400. A display device having an IP address A and a display device having an IP address C are in the chat room with room name R. A display device having an IP address B is in the chat room with room name S. A display device having an IP address D is in the chat room with room name T.

As will be described hereinafter, room name R is determined by CPU 406 based on the mail address of the display device having IP address A and the mail address of the display device having IP address B. In the state shown in FIG. 9(a), when the display device having an IP address E newly enters the chat room with room name S, then, as shown in FIG. 9(b), room management table 406A associates room name S with IP address E and thus stores them.

More specifically, when chat server 400 receives a request from first mobile phone 100A to generate a new chat room (as indicated in FIG. 2 at step S0002), CPU 405 generates a room name based on the mail address of first mobile phone 100A and the mail address of second mobile phone 100B, and then stores that room name in room management table 406A in association with the IP address of first mobile phone 100A.

Then, when second mobile phone 100B requests chat server 400 to allow second mobile phone 100B to enter a chat room (as indicated in FIG. 2 at step S0008), CPU 405 associates this room name with the IP address of second mobile phone 100B and thus stores them in room management table 406A. CPU 406 reads from room management table 406A the IP address of first mobile phone 100A associated with this room name. CPU 406 transmits the IP address of first mobile phone 100A to each second display device, and transmits the IP address of second mobile phone 100B to first mobile phone 100A.

Then, the hardware configuration of contents server 600 will be described. As shown in FIG. 8, contents server 600 according to the present embodiment includes a CPU 605, a memory 606, a fixed disk 607, and a server communication device 609 interconnected by an internal bus 608.

Memory 606 stores a variety of types of information, and for example, temporarily stores data required for execution of a program in CPU 605. Fixed disk 607 stores a program executed by CPU 605, a database, and the like. CPU 605, which controls each element of contents server 600, is a device performing a variety of types of operations. Server communication device 609 receives data output from CPU 605, converts the data into an electrical signal, and externally transmits the signal. Server communication device 609 also converts the externally received electrical signal into data for input to CPU 605. More specifically, server communication device 609 receives data from CPU 605 and transmits the data via Internet 500, carrier network 700, and/or the like to a device connectable to a network, such as mobile phone 100, car navigation device 200, personal computer 300, a game machine, an electronic dictionary, an electronic BOOK, and the like. Server communication device 609 inputs, to CPU 605, data received via Internet 500, carrier network 700 and/or the like from a device connectable to a network, such as mobile phone 100, car navigation device 200, personal computer 300, a game machine, an electronic dictionary, an electronic BOOK, and the like.

Memory 606 or fixed disk 615 in contents server 600 stores moving image contents. CPU 605 in contents server 600 receives designation of contents from first mobile phone 100A and second mobile phone 100B via server communication device 609. CPU 605 in contents server 600 reads, from memory 606, moving image contents corresponding to the designation based on the designation of contents, and transmits the contents to first mobile phone 100A and second mobile phone 100B via server communication device 609. The moving image contents represent streaming data or the like, and contents server 600 distributes the same contents to first mobile phone 100A and second mobile phone 100B substantially at the same time.

### <Communication Process in Network System 1>

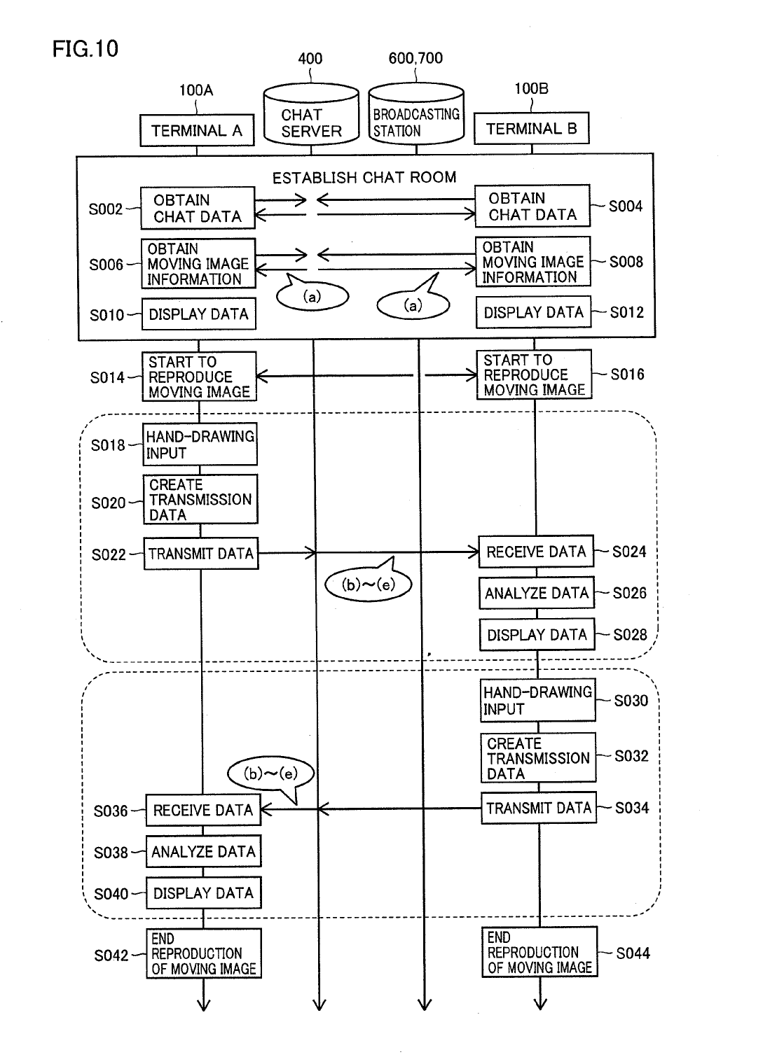

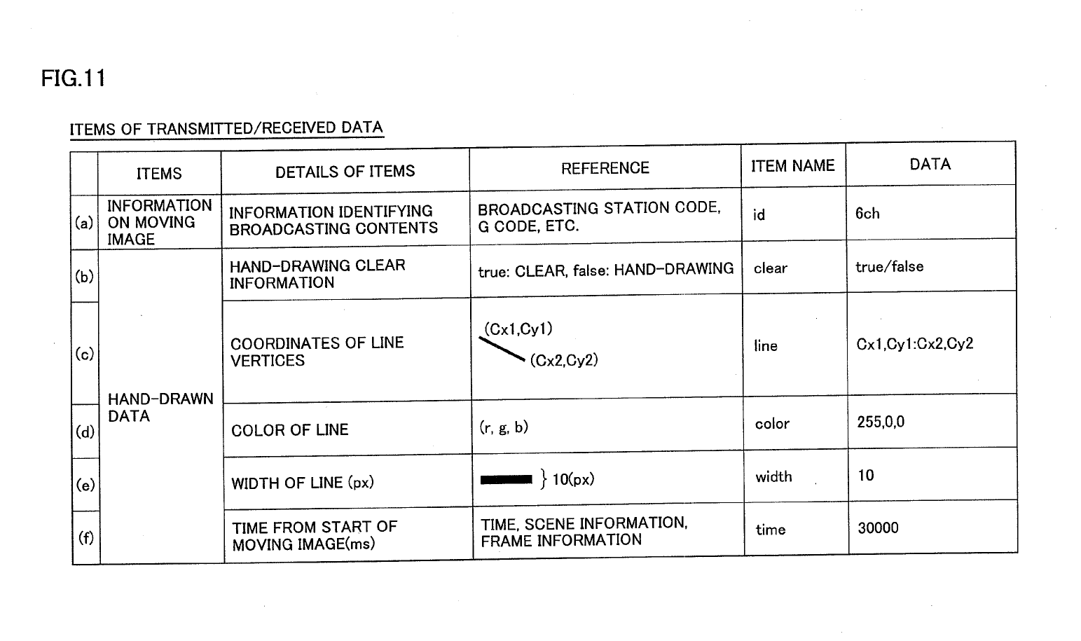

The P2P communication process in network system 1 according to the present embodiment will be hereinafter described. FIG. 10 is a flowchart showing a procedure of the P2P communication process in network system 1 according to the present embodiment. FIG. 11 is a representation of the data structure of transmission data according to the present embodiment.

In the following, description will be made on the case where hand-drawn data is transmitted from first mobile phone 100A to second mobile phone 100B. It is noted that first mobile phone 100A and second mobile phone 100B may transmit/receive data to/from each other via chat server 400 after a chat room is established, or may transmit/receive data to/from each other by P2P communication without depending on chat server 400.

Referring to FIG. 10, CPU 106 of first mobile phone 100A (on the transmitting side) first obtains data about chat communication from chat server 400 via communication device 101 (step S002). Similarly, CPU 106 of second mobile phone 100B (on the receiving side) also obtains the data about chat communication from chat server 400 via communication device 101 (step S004).

CPU 106 of first mobile phone 100A obtains moving image information (a) for identifying moving image contents from the chat server via communication device 101 (step S006). As shown in FIG. 11, the moving image information (a) contains, for example, a broadcasting station code, a broadcasting time, and the like for identifying a TV program. Alternatively, the moving image information (a) contains a URL indicating a storage position of a moving image and the like. In the present embodiment, CPU 106 of one of first mobile phone 100A and second mobile phone 100B transmits moving image information to chat server 400 via communication device 101.

CPU 106 of the other one of first mobile phone 100A and second mobile phone 100B obtains moving image information from chat server 400 via communication device 101 (step S008). In addition, although first mobile phone 100A and second mobile phone 100B obtain moving image information during the chat communication in this example, the present invention is not limited thereto, but first mobile phone 100A and second mobile phone 100B may obtain common moving image information before the chat communication.

CPU 106 of first mobile phone 100A causes touch panel 102 to display a window in which moving image contents are to be reproduced (step S010). Similarly, CPU 106 of second mobile phone 100B causes touch panel 102 to display a window in which moving image contents are to be reproduced (step S012).

CPU 106 of first mobile phone 100A receives moving image contents (e.g., a TV program) via communication device 101 or TV antenna 113 based on the moving image information. CPU 106 starts reproducing the moving image contents via touch panel 102 (step S014). CPU 106 may output sound of the moving image contents through speaker 109.

CPU 106 of second mobile phone 100B receives the same moving image contents as those received by first mobile phone 100A via communication device 101 or TV antenna 113 based on the moving image information. CPU 106 starts reproducing the moving image contents via touch panel 102 (step S016). CPU 106 may output sound of the moving image contents through speaker 109.

First mobile phone 100A and second mobile phone 100B wait for an input of a hand-drawn image. First, description will be made on the case where CPU 106 of first mobile phone 100A receives input of a hand-drawn image from a user via touch panel 102 (step S018). More specifically, CPU 106 sequentially receives contact coordinate data from touch panel 102 at predetermined time intervals, thereby obtaining changes in (movement path of) a contact position on touch panel 102.

As shown in FIG. 11, CPU 106 generates transmission data containing hand-drawing clear information (b), information indicating the movement path of the contact position (c), information indicating the color of line (d), information indicating the width of line (e), and input timing information (1) (step S020).

It is noted that the input timing information (f) contains, for example, a time (ms) from the start of a program or a scene number and a frame number of the program, corresponding to the time when input of a hand-drawn image is received. In other words, the input timing information (f) contains information for identifying a scene, a frame or the like of moving image contents to be displayed together with a hand-drawn image in first mobile phone 100A and second mobile phone 100B.

Hand-drawing clear information (b) contains information (true) for clearing hand-drawing that has been input so far or information (false) for continuing hand-drawing input.

As shown in FIG. 4(A-1), CPU 106 causes display 107 to display a hand-drawn image on moving image contents (to be superimposed on the moving image contents) based on the transmission data.

CPU 106 transmits the transmission data to second mobile phone 100B via communication device 101 (step S022). CPU 106 of second mobile phone 100B receives the transmission data from first mobile phone 100A via communication device 101 (step S024).

It is noted that first mobile phone 100A may transmit transmission data to second mobile phone 100B via chat server 400. Chat server 400 may then accumulate the transmission data communicated between first mobile phone 100A and second mobile phone 100B.

CPU 106 of second mobile phone 100B analyzes the transmission data (step S026). As shown in FIG. 4(B-1), CPU 106 causes display 107 to display the hand-drawn image on the moving image contents (to be superimposed on the moving image contents) based on the transmission data (step S028).

Next, description will be made on the case where CPU 106 of second mobile phone 100B receives input of a hand-drawn image from a user via touch panel 102 (step S030). More specifically, CPU 106 sequentially receives contact coordinate data from touch panel 102 at every predetermined time interval, thereby obtaining changes in (movement path of) a contact position on touch panel 102.

As shown in FIG. 11, CPU 106 generates transmission data containing hand-drawing clear information (b), information indicating the movement path of the contact position (c), information indicating the color of line (d), and information indicating the width of line (e) (step S032). The hand-drawing clear information (b) contains information (true) for clearing hand-drawing that has been input so far or information (false) for continuing hand-drawing input.

As shown in FIG. 4(B-3), CPU 106 causes display 107 to display the hand-drawn image on the moving image contents (to be superimposed on the moving image contents) based on the transmission data.

CPU 106 transmits transmission data to first mobile phone 100A via communication device 101 (step S034). CPU 106 of first mobile phone 100A receives transmission data from second mobile phone 100B via communication device 101 (step S036).

CPU 106 of first mobile phone 100A analyzes the transmission data (step S038). As shown in FIG. 4(A-3), CPU 106 causes display 107 to display the hand-drawn image on the moving image contents (to be superimposed on the moving image contents) based on the transmission data (step S040).

When reproduction of the moving image contents identified by the moving image information is completed, CPU 106 of first mobile phone 100A closes the window for the moving image contents (step S042). When reproduction of the moving image contents identified by the moving image information is completed, CPU 106 of second mobile phone 100A closes the window for the moving image contents (step S044).

### <Input Process in Mobile Phone 100>

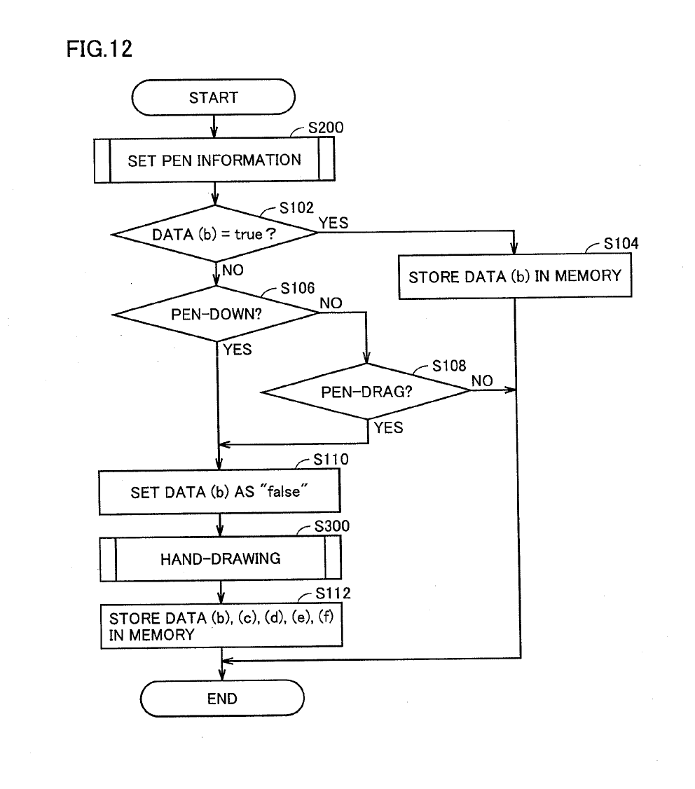

Next, an input process in mobile phone 100 according to the present embodiment will be described hereinafter. FIG. 12 is a flowchart illustrating a procedure of the input process in mobile phone 100 according to the present embodiment.

Referring to FIG. 12, when input to mobile phone 100 is started, CPU 106 first executes a pen information setting process (step S200). It is noted that the pen information setting process (step S200) will be described later.

When the pen information setting process (step S200) ends, CPU 106 determines whether or not data (b) is “true” (step S102). When data (b) is “true” (YES in step S102), that is, when a user inputs an instruction to clear a hand-drawn image, CPU 106 stores data (b) in memory 103 (step S104). CPU 106 ends the input process.

When data (b) is not “true” (NO in step S102), that is, when the user inputs an instruction other than the instruction for clearing, CPU 106 determines whether or not stylus pen 120 has contacted touch panel 102 (step S106). That is, CPU 106 determines whether or not pen-down has been detected.

When pen-down has not been detected (NO in step S106), CPU 106 determines whether or not the contact position of stylus pen 120 on touch panel 102 has been changed (step S108). That is, CPU 106 determines whether or not pen-drag has been detected. When pen-drag has not been detected (NO in step S108), CPU 106 ends the input process.

When pen-down has been detected (YES in step S106) or when pen-drag has been detected (YES in step S108), CPU 106 sets data (b) as “false” (step S110). CPU 106 executes a hand-drawing process (step S300). The hand-drawing process (step S300) will be described later.

When the hand-drawing process ends (step S300), CPU 106 stores data (b), (c), (d), (e), and (f) in memory 103 (step S112). CPU 106 ends the input process.

### <Pen Information Setting Process in Mobile Phone 100>

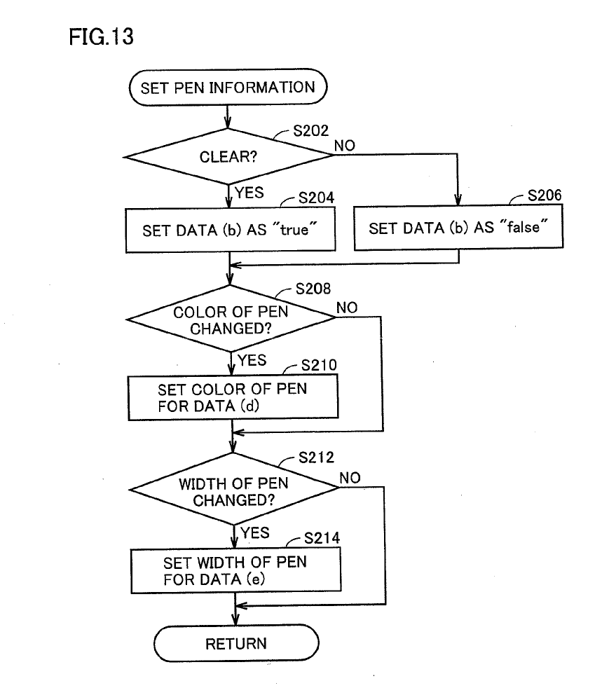

Next, the pen information setting process in mobile phone 100 according to the present embodiment will be described. FIG. 13 is a flowchart showing a procedure of the pen information setting process in mobile phone 100 according to the present embodiment.

Referring to FIG. 13, CPU 106 determines whether or not the instruction to clear (delete or reset) a hand-drawn image has been received from the user via touch panel 102 (step S202). When the instruction to clear a hand-drawn image has been received from the user (YES in step S202), CPU 106 sets data (b) as “true” (step S204). CPU 106 executes the process from step S208.

When the instruction to clear a hand-drawn image has not been received from the user (NO in step S202), CPU 106 sets data (b) as “false” (step S206). However, CPU 106 does not need to perform setting as “false” here.

CPU 106 determines whether or not an instruction to change the color of pen has been received from the user via touch panel 102 (step S208). When the instruction to change the color of pen has not been received from the user (NO in step S208), CPU 106 executes the process from step S212.

When the instruction to change the color of pen has been received from the user (YES in step S208), CPU 106 sets the changed color of pen for data (d) (step S210). CPU 106 determines whether or not an instruction to change the width of pen has been received from the user via touch panel 102 (step S212). When the instruction to change the width of pen has not been received from the user (NO in step S212), CPU 106 ends the pen information setting process.

When the instruction to change the width of pen has been received from the user (YES in step S212), CPU 106 sets the changed width of pen for data (e) (step S214). CPU 106 ends the pen information setting process.

### <Hand-drawing Process in Mobile Phone 100>

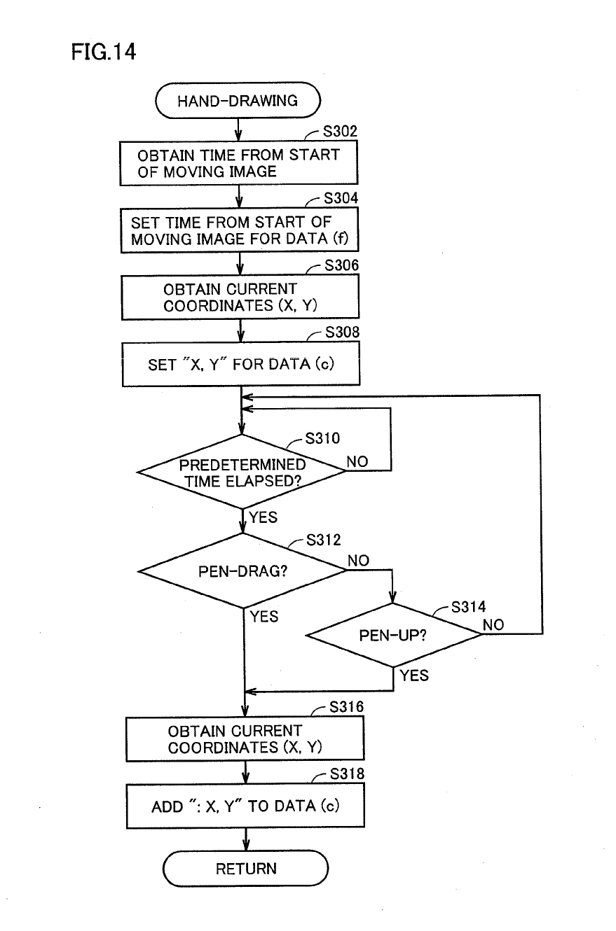

Next, description will be made on the hand-drawing process in mobile phone 100 according to the present embodiment. FIG. 14 is a flowchart showing a procedure of the hand-drawing process in mobile phone 100 according to the present embodiment.

Referring to FIG. 14, CPU 106 refers to a clock not shown or refers to moving image contents to obtain a time from the start of the moving image contents (step S302). CPU 106 sets the time from the start of the moving image contents for data (f) (step S304).

CPU 106 obtains via touch panel 102 the current contact coordinates (X, Y) on touch panel 102 made by stylus pen 120 or a finger (step S306). CPU 106 sets “X, Y” for data (c) (step S308).

CPU 106 determines (step S310) whether or not a predetermined time has elapsed since the previous coordinates have been obtained (step S308). When the predetermined time has not elapsed (NO in step S310), CPU 106 repeats the process from step S310. When the predetermined time has elapsed (YES in step S310), CPU 106 determines whether or not pen-drag has been detected via touch panel 102 (step S312).

When pen-drag has been detected (YES in step S312), CPU 106 obtains via touch panel 102 the contact position coordinates (X, Y) on touch panel 102 made by stylus pen 120 or a finger (step S316). CPU 106 adds “: X, Y” to data (c) (step S318). CPU 106 ends the hand-drawing process.

When pen-drag has not been detected (NO in step S312), CPU 106 determines whether or not pen-up has been detected (step S314). When pen-up has not been detected (NO in step S314), CPU 106 repeats the process from step S310.

When pen-up has been detected (YES in step S314), CPU 106 obtains via touch panel 102 the contact position coordinates (X, Y) on touch panel 102 made by the stylus pen at the time of pen-up (step S316). CPU 106 adds “: X, Y” to data (c) (step S318). CPU 106 ends the hand-drawing process.

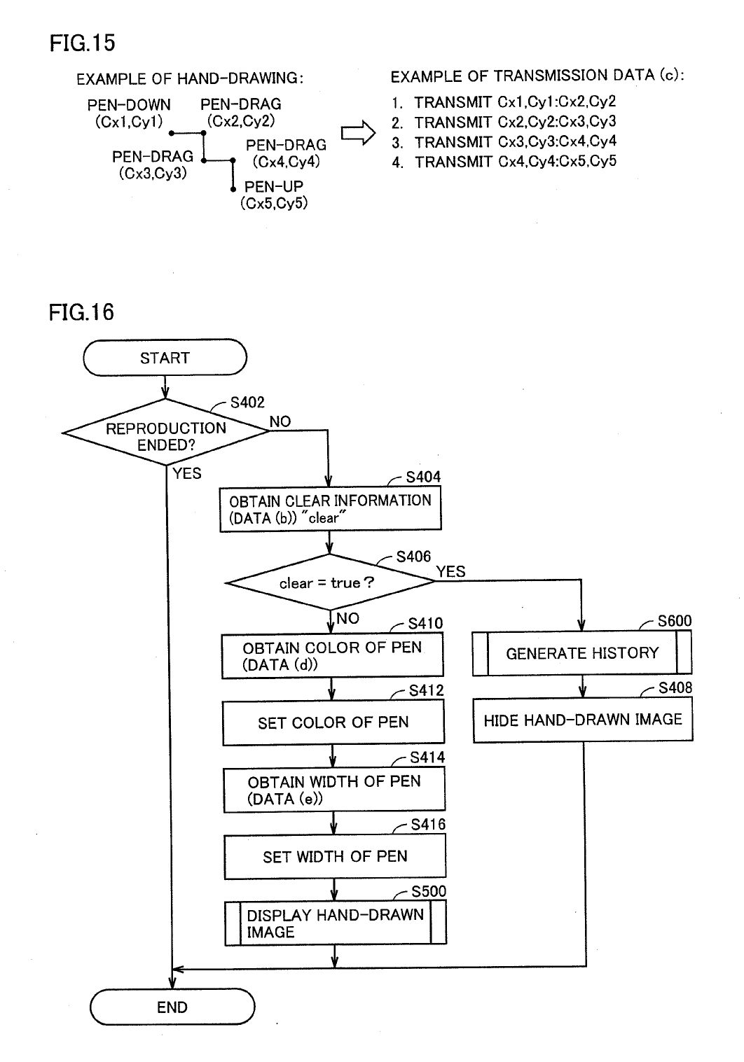

Description will now be made on data (c) showing a hand-drawn image according to the present embodiment. FIG. 15 is a representation of data (c) showing a hand-drawn image according to the present embodiment.

Referring to FIGS. 14 and 15, the display device according to the present embodiment transmits a plurality of continuous drag start coordinates and drag end coordinates at predetermined time intervals as information indicating a single hand-drawing stroke. That is, a single drag operation (slide operation) on touch panel 102 made by stylus pen 120 is represented as a group of contact coordinates on touch panel 102 made by stylus pen 120 at predetermined time intervals.

For example, when the contact coordinates regarding a single drag operation changes in the order of (Cx1, Cy1)→(Cx2, Cy2)→(Cx3, Cy3)→(Cx4, Cy4) (Cx5, Cy5), CPU 106 of first mobile phone 100A operates as described below. When an initial predetermined period elapses, that is, when coordinates (Cx2, Cy2) are obtained, CPU 106 transmits (Cx1, Cy1: Cx2, Cy2) as transmission data (c) to second mobile phone 100B using communication device 101. Further, when a predetermined period elapses, that is, when coordinates (Cx3, Cy3) are obtained, CPU 106 transmits (Cx2, Cy2: Cx3, Cy3) as transmission data (c) to second mobile phone 100B using communication device 101. Furthermore, when the predetermined period elapses, that is, when coordinates (Cx4, Cy4) are obtained, CPU 106 transmits (Cx3, Cy3: Cx4, Cy4) as transmission data (c) to second mobile phone 100B using communication device 101. Furthermore, when the predetermined period elapses, that is, when coordinates (Cx5, Cy5) are obtained, CPU 106 transmits (Cx4, Cy4: Cx5, Cy5) as transmission data (c) to second mobile phone 100B using communication device 101.

### <Display Process in Mobile Phone 100>

Next, description will be made on a display process in mobile phone 100 according to the present embodiment. FIG. 16 is a flowchart showing a procedure of the display process in mobile phone 100 according to the present embodiment.

Referring to FIG. 16, CPU 106 determines whether or not reproduction of moving image contents has ended (step S402). When reproduction of moving image contents has ended (YES in step S402), CPU 106 ends the display process. When reproduction of moving image contents has not ended (NO in step S402),

CPU 106 obtains clear information “clear” (data (b)) (step S404). CPU 106 determines whether or not clear information “clear” is “true” (step S406). When clear information “clear” is “true” (YES in step S406), CPU 106 executes a history generating process (step S600). The history generating process (step S600) will be described later.

When the history generating process (step S600) ends, CPU 106 hides a hand-drawn image having been displayed so far, using touch panel 102 (step S408). CPU 106 ends the display process.

When clear information “clear” is not “true” (NO in step S406), CPU 106 obtains the color of pen (data (d)) (step S410). CPU 106 then resets the color of pen (step S412), obtains the width of pen (data (e)) (step S414), and resets the width of pen (step S416).

CPU 106 executes a hand-drawn image display process (step S500). The hand-drawn image display process (step S500) will be described later. When the hand-drawn image display process (step S500) ends, CPU 106 ends the display process.

### <Application Example of Display Process in Mobile Phone 100>

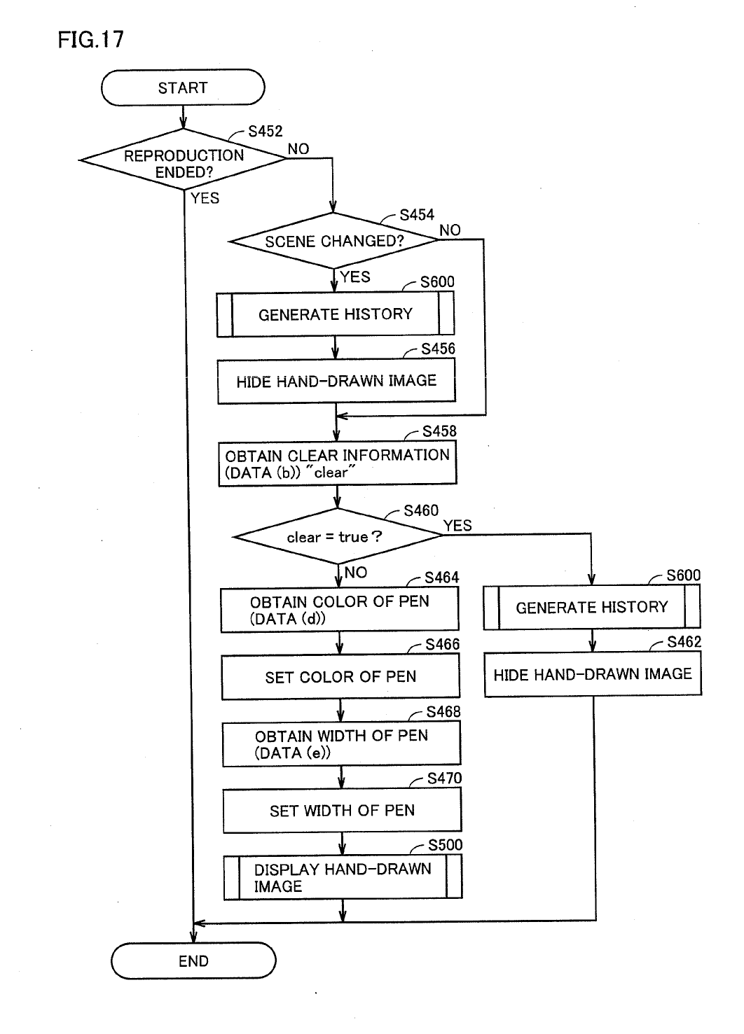

Next, description will be made on an application example of the display process in mobile phone 100 according to the present embodiment. FIG. 17 is a flowchart showing a procedure of the application example of the display process in mobile phone 100 according to the present embodiment. In this application example, mobile phone 100 clears (deletes or resets) a hand-drawn image that has been displayed so far, not only when clear information is received but also when the scene is changed.

Referring to FIG. 17, CPU 106 determines whether or not reproduction of moving image contents has ended (step S452). When reproduction of moving image contents has ended (YES in step S452), CPU 106 ends the display process.

When reproduction of moving image contents has not ended (NO in step S452), CPU 106 determines whether or not the scene of moving image contents has been changed (step S454). When the scene of moving image contents has not been changed (NO in step S454), CPU 106 executes the process from step S458.

When the scene of moving image contents has been changed (YES in step S454), CPU 106 executes the history generating process (step S600). CPU 106 hides a hand-drawn image having been displayed so far, using touch panel 102 (step S456). CPU 106 then obtains clear information “clear” (data (b)) (step S458).

CPU 106 determines whether or not clear information “clear” is “true” (step S460). When clear information “clear” is “true” (YES in step S460), CPU 106 executes the history generating process (step S600). CPU 106 hides the hand-drawn image having been displayed so far, using touch panel 102 (step S462). CPU 106 ends the display process.

When clear information “clear” is not “true” (NO in step S460), CPU 106 obtains the color of pen (data (d)) (step S464). CPU 106 resets the color of pen (step S466), obtains the width of pen (data (e)) (step S468), and resets the width of pen (step S470).

CPU 106 executes the hand-drawn image display process (step S500). The hand-drawn image display process (step S500) will be described later. CPU 106 ends the display process.

### <Hand-drawn Image Display Process in Mobile Phone 100>

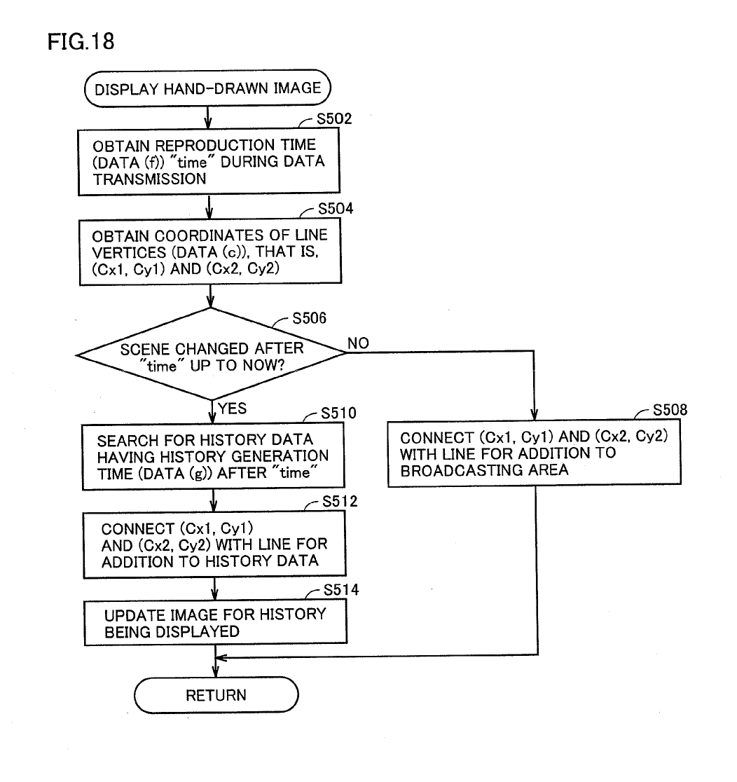

Next, description will be made on the hand-drawn image display process in mobile phone 100 according to the present embodiment. FIG. 18 is a flowchart showing a procedure of the hand-drawn image display process in mobile phone 100 according to the present embodiment.

Referring to FIG. 18, CPU 106 obtains a reproduction time “time” from the start of reproduction of moving image contents to data transmission (data (f)) (step S502). CPU 106 obtains the coordinates of vertices of a hand-drawn stroke (data (c)), namely, (Cx1, Cy1) and (Cx2, Cy2) at every predetermined time interval (step S504).

It is determined whether or not the scene of moving image contents has been changed during the time period from reproduction time “time” to the present (step S506). When the scene of moving image contents has not been changed (NO in step S506), CPU 106 connects the coordinates (Cx1, Cy1) and the coordinates (Cx2, Cy2) with a line, thereby drawing a hand-drawn stroke in a display region (first region 102A) for moving image contents (step S508). CPU 106 ends the hand-drawn image display process.

When the scene of moving image contents has been changed (YES in step S506), CPU 106 searches for the oldest piece of history data through history data having a history generation time (data (g)) later than reproduction time “time” for the received hand-drawn data (step S510). CPU 106 connects the coordinates (Cx1, Cy1) and the coordinates (Cx2, Cy2) with a line, thereby adding information about the hand-drawn stroke to the history data corresponding to this history generation time (data (g)) (step S512).

CPU 106 updates the history image being displayed on touch panel 102 (step S514). CPU 106 ends the hand-drawn image display process.

### <First History Generating Process in Mobile Phone 100>

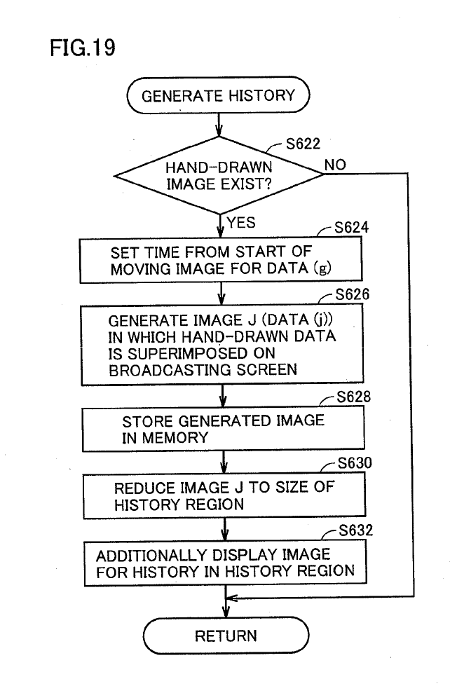

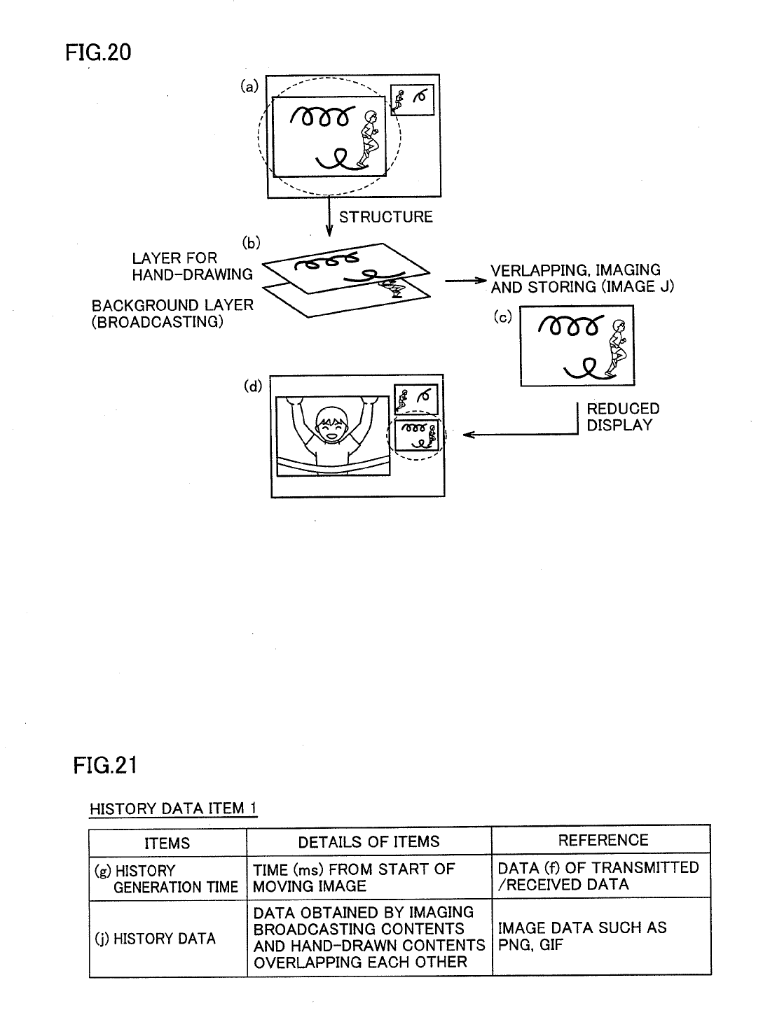

Next, description will be made on the first history generating process in mobile phone 100 according to the present embodiment. FIG. 19 is a flowchart showing a procedure of the first history generating process in mobile phone 100 according to the present embodiment. FIG. 20 is a representation of history data according to the first history generating process. FIG. 21 is a diagram showing a data structure of history information according to the first history generating process.

Referring to FIG. 19, CPU 106 determines whether or not a hand-drawn image is displayed in the display region of moving image contents (first region 102A) (step S622). When a hand-drawn image is not displayed (NO in step S622), CPU 106 ends the first history generating process.

As shown in FIG. 20(a), when a hand-drawn image is displayed (YES in step S622), CPU 106 sets the time from the start of a moving image to the current time point for data (g) (step S624). As shown in FIGS. 20(b) and 20(c), CPU 106 superimposes a hand-drawn image being displayed and a frame (still image) immediately before the current time point among the frames constituting the moving image contents, to generate a history image J (paint data j) (step S626).

CPU 106 stores the generated image in memory 103 (step S628). More specifically, as shown in FIG. 21, CPU 106 associates the time when the history data is generated (data (g)) with history image J (paint data j), and stores the associated time and image in memory 103 as history information. It is noted that the time when the history data is generated includes the time when history image J is stored in memory 103. Alternatively, the time when the history data is generated includes a contents reproduction time from the beginning of moving image contents until the frame to be a history image is displayed (a time on the time axis with respect to the starting point of contents). Further alternatively, the time when the history data is generated includes a time from the beginning of moving image contents until the instruction to clear a hand-drawn image is input or a time from the beginning of moving image contents until the scene is changed this time.

CPU 106 reduces image J based on image J in memory 103 (step S630).

As shown in FIG. 20(d), CPU 106 causes the reduced image to be displayed in a history region (second region 102B) of touch panel 102 (step S632). CPU 106 ends the first history generating process.

### <Second History Generating Process in Mobile Phone 100>

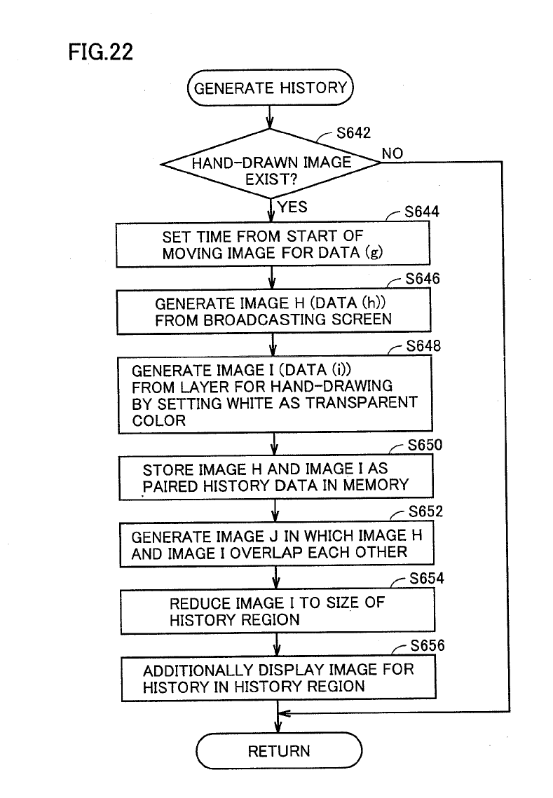

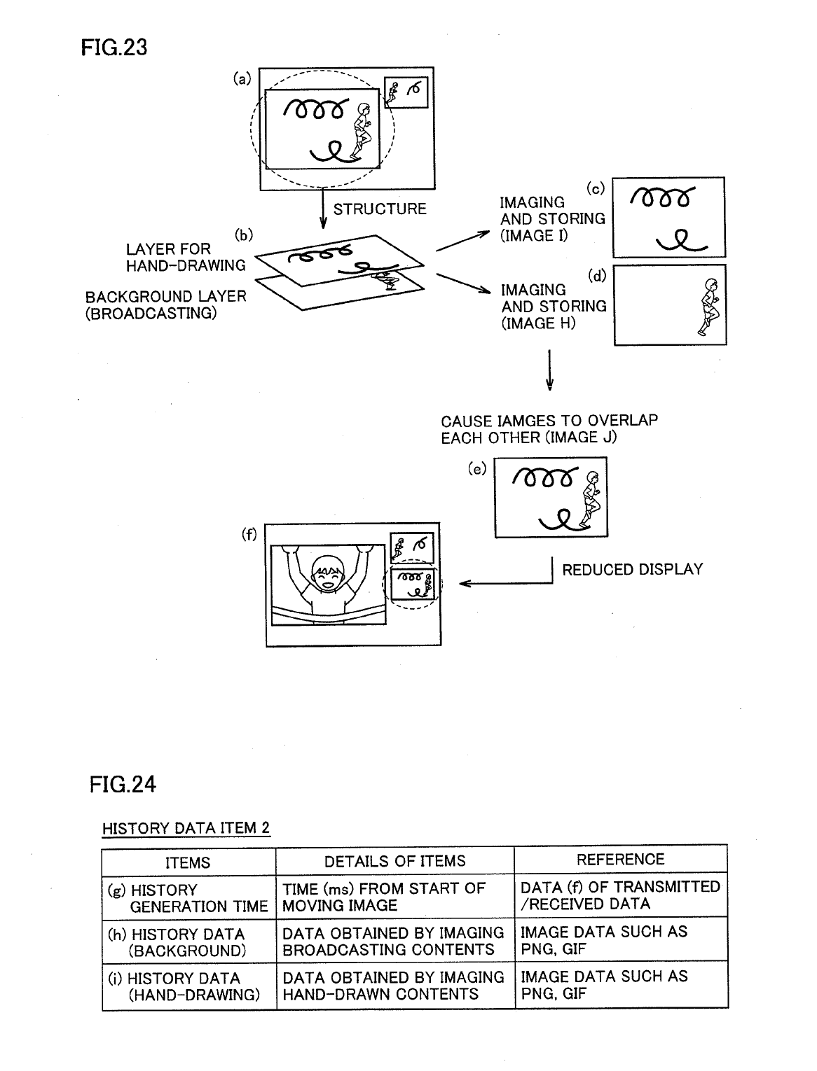

Next, description will be made on the second history generating process in mobile phone 100 according to the present embodiment. FIG. 22 is a flowchart showing a procedure of the second history generating process in mobile phone 100 according to the present embodiment. FIG. 23 is a representation of history data according to the second history generating process. FIG. 24 is a diagram showing a data structure of history information according to the second history generating process.

Referring to FIG. 22, CPU 106 determines whether or not a hand-drawn image is displayed in the display region (first region 102A) of moving image contents (step S642). When a hand-drawn image is not displayed (NO in step S642), CPU 106 ends the second history generating process.

As shown in FIG. 23(a), when a hand-drawn image is displayed (YES in step S642), CPU 106 sets the time from the start of a moving image to the current time point for data (g) (step S644). As shown in FIGS. 23(b) and 23(d), CPU 106 generates a frame (an image H) immediately before the current time point among the frames constituting moving image contents (step S646). As shown in FIGS. 23(b) and 23(c), CPU 106 sets white as a transparent color based on a layer for hand-drawing, thereby generating a hand-drawn image I being displayed (step S648).

CPU 106 stores the generated image H of moving image contents and hand-drawn image I in memory 103 (step S650). More specifically, as shown in FIG. 24, CPU 106 associates the time when the history data is generated (data (g)), image H of moving image contents (paint data h) and hand-drawn image I (paint data i) with one another, and thus stores them in memory 103 as history information. It is noted that the time when the history data is generated includes the time when history image J is stored in memory 103. Alternatively, the time when the history data is generated includes a contents reproduction time from the beginning of moving image contents until the frame to be a history image is displayed (a time on the time axis with respect to the starting point of contents). Further alternatively, the time when the history data is generated includes a time from the beginning of moving image contents until the instruction to clear a hand-drawn image is input or a time from the beginning of moving image contents until the scene is changed this time.

As shown in FIG. 23(e), CPU 106 combines image H of moving image contents and image I in memory 103 to generate image J (step S652). CPU 106 reduces image J (step S654).

As shown in FIG. 23(f), CPU 106 causes the reduced image to be displayed in the history region (second region) of touch panel 102 (step S656). CPU 106 ends the second history generating process.

### <Third History Generating Process in Mobile Phone 100>

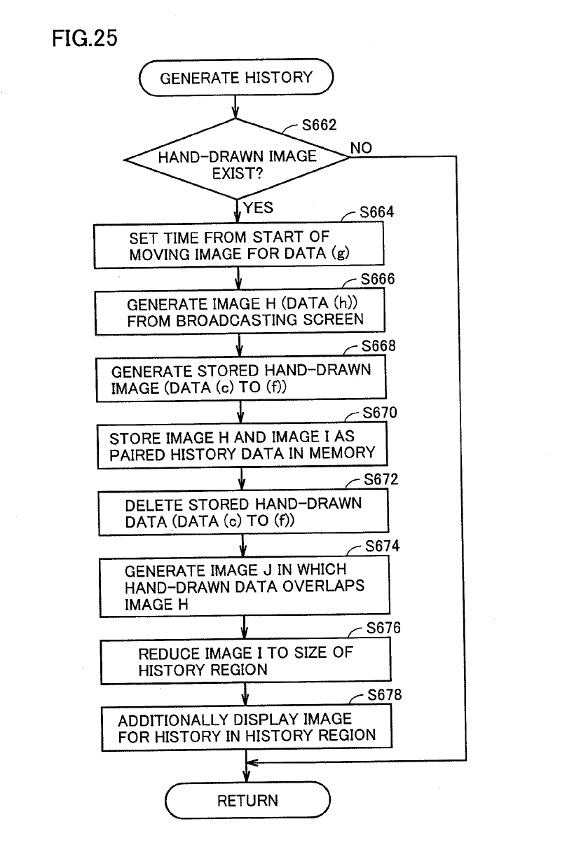

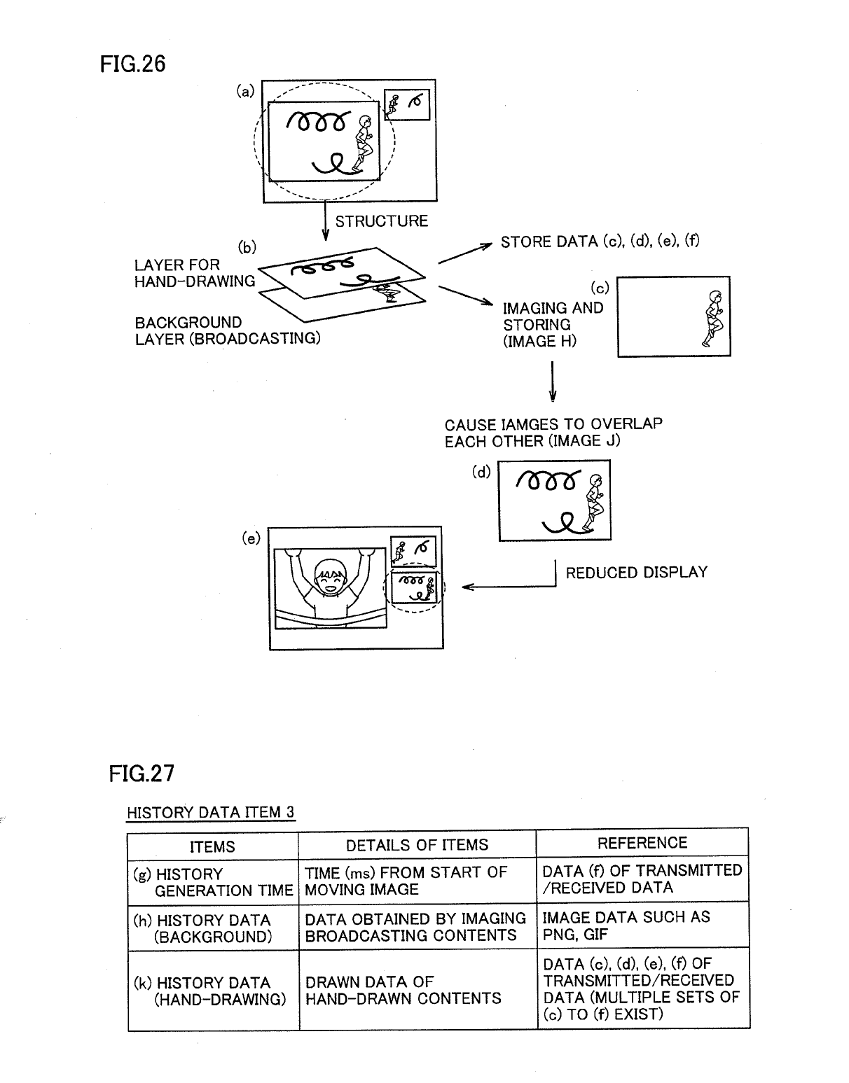

Next, description will be made on the third history generating process in mobile phone 100 according to the present embodiment. FIG. 25 is a flowchart showing a procedure of the third history generating process in mobile phone 100 according to the present embodiment. FIG. 26 is a representation of history data according to the third history generating process. FIG. 27 is a diagram showing a data structure of history information according to the third history generating process.

Referring to FIG. 25, CPU 106 determines whether or not a hand-drawn image is displayed in the display region (first region 102A) of moving image contents (step S662). When a hand-drawn image is not displayed (NO in step S662), CPU 106 ends the third history generating process.

As shown in FIG. 26(a), when a hand-drawn image is displayed (YES in step S662), CPU 106 sets a time from the start of a moving image to the current time point for data (g) (step S664). As shown in FIGS. 26(b) and 26(c), CPU 106 generates a frame (image H) immediately before the current time point among the frames constituting the moving image contents (step S666). CPU 106 generates draw data (a combination of data (c) to data (f)) representing the hand-drawn image being displayed (step S668).

CPU 106 stores the generated image H of moving image contents and draw data in memory 103 (step S670). More specifically, as shown in FIG. 27, CPU 106 associates the time when the history data is generated (data (g)), image H of moving image contents (paint data h) and draw data (a set of a plurality of data groups (c) to (f)), and thus stores them in memory 103. It is noted that the time when the history data is generated includes the time when history image J is stored in memory 103. Alternatively, the time when the history data is generated includes a contents reproduction time from the beginning of moving image contents until the frame to be a history image is displayed (a time on the time axis with respect to the starting point of contents). Further alternatively, the time when the history data is generated includes a time from the beginning of moving image contents until the instruction to clear a hand-drawn drawn image is input or a time from the beginning of moving image contents until the scene is changed this time.

CPU 106 deletes the hand-drawn image in memory 103 (step S672). As shown in FIG. 26(d), CPU 106 generates hand-drawn image I from draw data (k), and combines image H of moving image contents with hand-drawn image I that are stored in memory 103, thereby generating image J (step S674). CPU 106 reduces image J (step S676).

As shown in FIG. 26(e), CPU 106 causes the reduced image to be displayed in the history region (second region 102B) of touch panel 102 (step S678). CPU 106 ends the third history generating process.

### Second Embodiment

Next, description will be made on the second embodiment of the present invention. In network system 1 according to the above-described first embodiment, each display device stores only the history information on the scene being displayed when a hand-drawn image is input or the scene being displayed when a hand-drawn image is received. In other words, each display device deletes a frame of the moving image regarding a scene in which a hand-drawn image is not input and in which a hand-drawn image is not received, when this scene ends.

This is because a large amount of memory is to be required if all of moving image frames are stored for every scene even though a hand-drawn image is not input.

This is also because the user does not request to display all of moving image frames. In addition, this is also because, if all of moving image frames are displayed or stored, it will be difficult for the user or the display device to find out history information the user actually needs. However, after a moving image frame is deleted from the display device, the display device may receive from another display device a hand-drawn image input during the scene corresponding to this moving image frame. In this case, the display device can no longer cause this hand-drawn image and this moving image frame to be displayed in a superimposed manner. Such a defect is likely to occur, for example, when a failure occurs in a network among display devices or when this network is crowded.

In network system 1 according to the present embodiment, during display of scenes, each display device temporarily stores image data representing the last frame of each scene even if a hand-drawn image is not input to each display device or even if each display device does not receive a hand-drawn image. For example, each display device stores image data representing the last frame for ten scenes in memory 103 as temporary information. Then, each display device deletes the image data representing the last frame of each scene when a hand-drawn image corresponding to each scene is not received from another display device until after ten scenes from each scene.

It is noted that the configuration similar to that of network system 1 according to the first embodiment will not be repeated. For example, the general configuration of network system 1 in FIG. 1, the general outline of the operation of network system 1 in FIGS. 2 and 3, the outline of the operation regarding transmission/reception of written data in FIG. 4, the hardware configuration of mobile phone 100 in FIGS. 5 to 7, the hardware configurations of chat server 400 and contents server 600 in FIGS. 8 and 9, the P2P communication process in network system 1 in FIG. 10, the data structure of transmission data in FIG. 11, the input process in the mobile phone in FIG. 12, the pen information setting process in FIG. 13, the hand-drawing process in FIG. 14, the data showing the hand-drawn image in FIG. 15, the display process in FIG. 16, and the application example of the display process in FIG. 17 are similar to those according to the present embodiment. Therefore, description thereof will not be repeated.

It is to be noted that the present embodiment in FIG. 4 has the following characteristics. In the present embodiment, if a hand-drawn image is not input to second mobile phone 100B unlike as shown in (B-3) and if a hand-drawn image is input to first mobile phone 100A as shown in (A-4) while a network failure occurs, second mobile phone 100B can still display the hand-drawn image input to first mobile phone 100A as history information as shown in (B-5).

In the present embodiment, even if a hand-drawn image is not input to second mobile phone 100B during a scene unlike as shown in (B-3), second mobile phone 100B stores the last frame of that scene as temporary information. Therefore, even if a hand-drawn image is received from first mobile phone 100A after the scene is changed to the next scene as shown in (B-5), the last frame of the previous scene and this hand-drawn image can be stored and displayed as history information based on this temporary information and this hand-drawn image.

### <Hand-drawn Image Display Process in Mobile Phone 100>

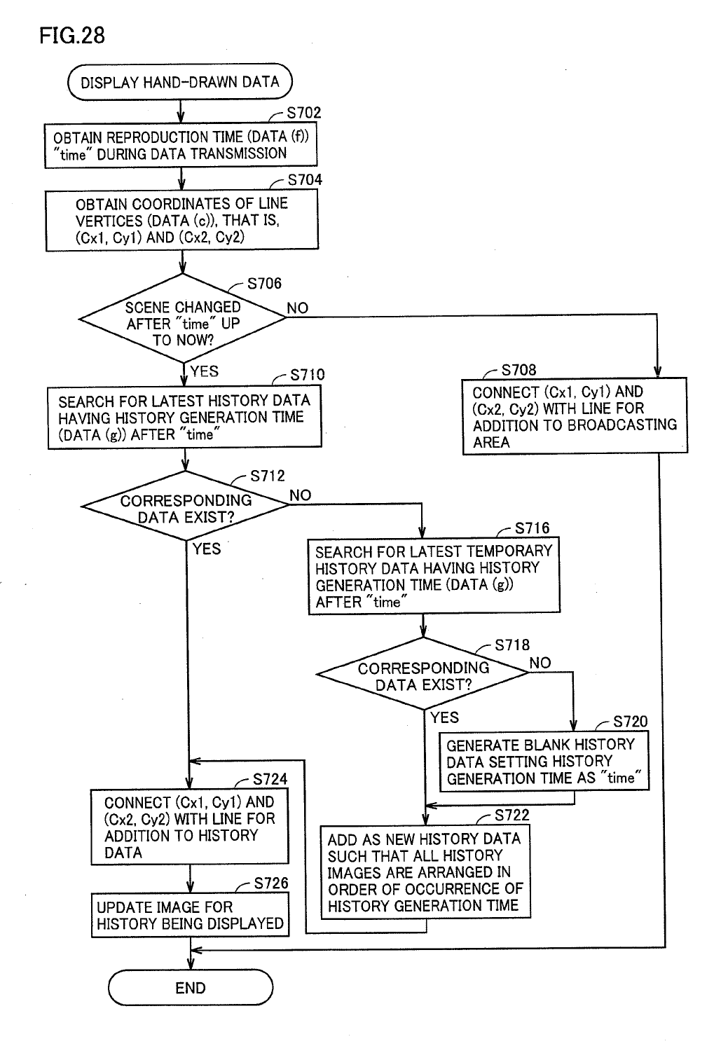

Next, description will be made on the hand-drawn image display process in mobile phone 100 according to the present embodiment. FIG. 28 is a flowchart showing a procedure of the hand-drawn image display process in mobile phone 100 according to the present embodiment.

Referring to FIG. 28, CPU 106 obtains reproduction time “time” (data (f)) from the start of reproduction of moving image contents to data transmission (step S702). CPU 106 obtains coordinates of vertices of a hand-drawn stroke (data (c)), namely, (Cx1, Cy1) and (Cx2, Cy2), at predetermined time intervals (step S704).

It is determined whether or not the scene of moving image contents has been changed during the time period from reproduction time “time” to the present (step S706). When the scene of moving image contents has not been changed (NO in step S706), CPU 106 connects the coordinates (Cx1, Cy1) and the coordinates (Cx2, Cy2) with a line, thereby drawing a hand-drawn stroke in the display region (first region 102A) of moving image contents (step S708). CPU 106 ends the hand-drawn image display process.

When the scene of moving image contents has been changed (YES in step S706), CPU 106 searches for the latest piece of history data through history data having a history generation time (data (g)) later than reproduction time “time” for the received hand-drawn data (step S710). When this latest piece of history data exists (YES in step S712), CPU 106 connects the coordinates (Cx1, Cy1) and the coordinates (Cx2, Cy2) with a line, thereby adding information on the hand-drawn stroke to this history data (step S724).

When the latest piece of history data does not exist (NO in step S712), CPU 106 searches for the latest piece of temporary history data through temporary history data having a history generation time (data (g)) later than reproduction time “time” for the received hand-drawn data (step S716). When this temporary history data does not exist (NO in step S718), CPU 106 generates blank history data setting the history generation time as “time” (step S720). CPU 106 executes the process in step S722.

When this temporary history data exists (YES in step S718), this temporary history data is added to existing history data as new history data (step S722). CPU 106 connects the coordinates (Cx1, Cy1) and the coordinates (Cx2, Cy2) with a line, thereby adding information on the hand-drawn stroke to this new history data (step S724).

CPU 106 causes touch panel 102 to display the history image based on this new history data and the previous history data (step S726). CPU 106 ends the hand-drawn image display process.

### <First History Generating Process in Mobile Phone 100>

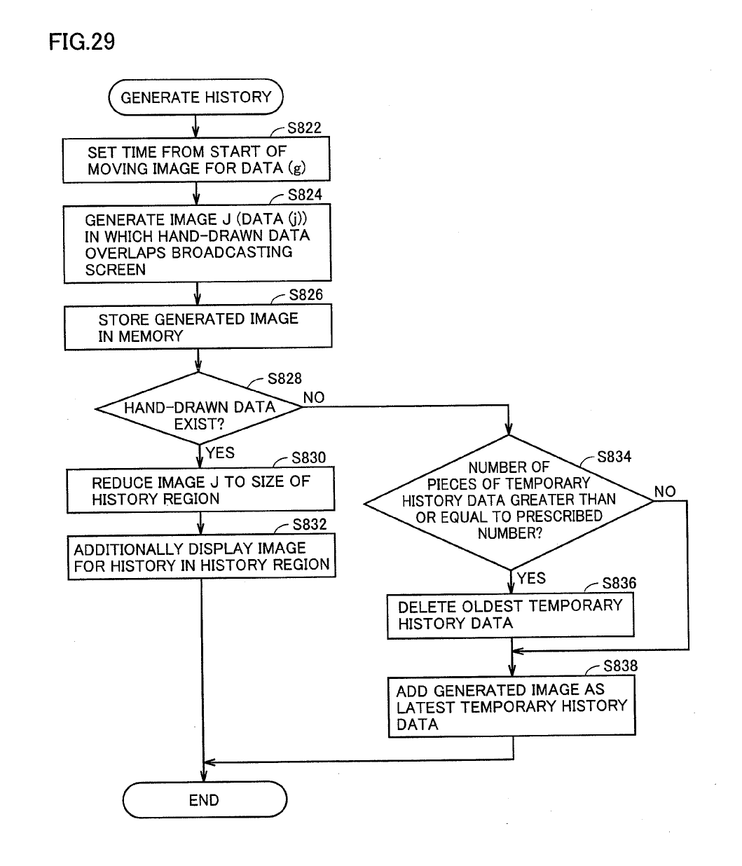

Next, description will be made on the first history generating process in mobile phone 100 according to the present embodiment. FIG. 29 is a flowchart showing a procedure of the first history generating process in mobile phone 100 according to the present embodiment.

As shown in FIGS. 29 and 20(a), CPU 106 sets a time from the start of a moving image to the current time point for data (g) (step S822). As shown in FIGS. 20(b) and 20(c), CPU 106 superimposes a hand-drawn image being displayed and a frame (still image) immediately before the current time point among the frames constituting the moving image contents, to generate history image J (paint data j) (step S824).

CPU 106 stores the generated image in memory 103 (step S826). More specifically, as shown in FIG. 21, CPU 106 associates the time when the history data is generated (data (g)) with history image J (paint data j), and thus stores them in memory 103 as history information. It is noted that the time when the history data is generated includes the time when history image J is stored in memory 103. Alternatively, the time when the history data is generated includes a contents reproduction time from the beginning of moving image contents until the frame to be a history image is displayed (a time on the time axis with respect to the starting point of contents). Further alternatively, the time when the history data is generated includes a time from the beginning of moving image contents until the instruction to clear a hand-drawn image is input or a time from the beginning of moving image contents until the scene is changed this time.

CPU 106 determines whether or not a hand-drawn image is included in image J (step S828). When a hand-drawn image is included in image J (YES in step S828), CPU 106 reduces image J based on image J in memory 103 as shown in FIG. 20(d) (step S830). CPU 106 stores the reduced image in memory 103 as history data.

As shown in FIG. 20(e), CPU 106 causes the reduced image to be displayed in the history region (second region 102B) of touch panel 102 (step S832). CPU 106 ends the first history generating process.

When a hand-drawn image is not included in image J (NO in step S828), CPU 106 determines whether or not the number of pieces of temporary history data is greater than or equal to a prescribed number (step S834). When the number of pieces of temporary history data is greater than or equal to the prescribed number (YES in step S834), CPU 106 deletes the oldest piece of temporary history data from memory 103 (step S836), and adds the generated image to the temporary history data (step S838). CPU 106 then ends the first history generating process.

When the number of pieces of temporary history data is less than the prescribed number (NO in step S834), CPU 106 adds the generated image to the temporary history data (step S838). CPU 106 ends the first history generating process.

### <Second History Generating Process in Mobile Phone 100>

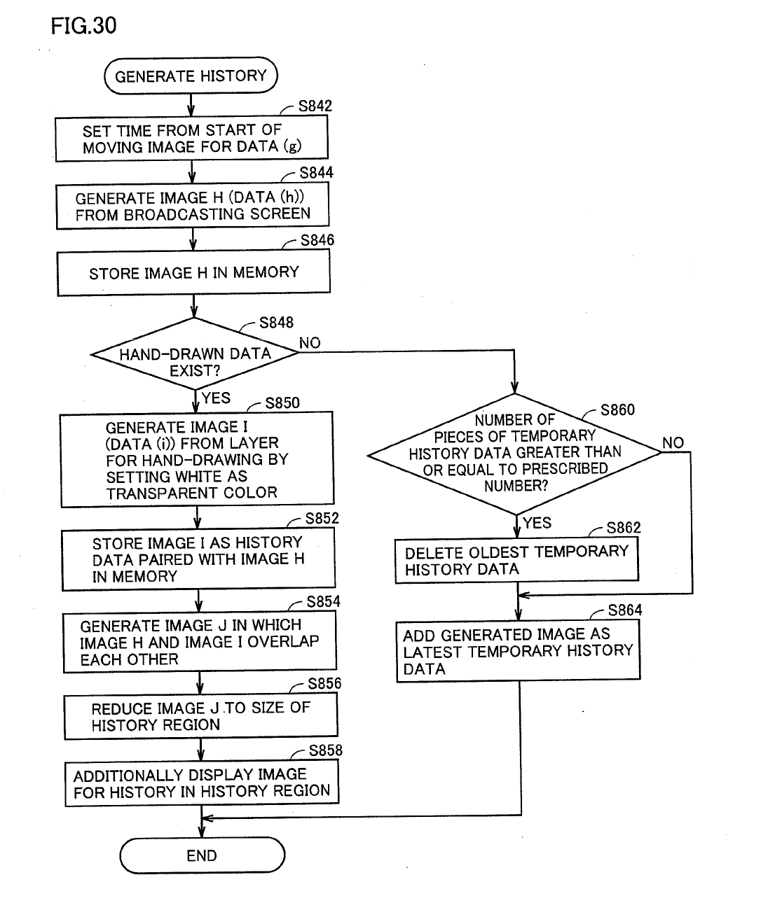

Next, description will be made on the second history generating process in mobile phone 100 according to the present embodiment. FIG. 30 is a flowchart showing a procedure of the second history generating process in mobile phone 100 according to the present embodiment.

As shown in FIGS. 30 and 23(a), CPU 106 sets a time from the start of a moving image to the current time point for data (g) (step S842). As shown in FIGS. 23(b) and 23(d), CPU 106 generates a frame (image H) immediately before the current time point among the frames constituting the moving image contents (step S844). CPU 106 stores generated image H of moving image contents in memory 103 (step S846). More specifically, CPU 106 associates the time when image H of moving image contents is generated (data (g)) with image H of moving image contents (paint data h), and thus stores them in memory 103.

CPU 106 determines whether or not a hand-drawn image exists on the moving image (step S848). When a hand-drawn image exists on the moving image (YES in step S848), as shown in FIGS. 23(b) and 23(c), CPU 106 sets white as a transparent color based on a layer for hand-drawing, thereby generating hand-drawn image I being displayed (step S850).

CPU 106 associates generated image H of moving image contents and hand-drawn image I with each other, and thus stores them in memory 103 (step S852). More specifically, as shown in FIG. 24, CPU 106 associates the time when history data is generated (data (g)), image H of moving image contents (paint data h) and hand-drawn image I (paint data i) with one another, and thus stores them in memory 103 as history information. It is noted that the time when the history data is generated includes the time when history image J is stored in memory 103. Alternatively, the time when the history data is generated includes a contents reproduction time from the beginning of moving image contents until the frame to be a history image is displayed (a time on the time axis with respect to the starting point of contents). Further alternatively, the time when the history data is generated includes a time from the beginning of moving image contents until the instruction to clear a hand-drawn image is input or a time from the beginning of moving image contents until the scene is changed this time.

As shown in FIG. 23(e), CPU 106 combines image H of moving image contents and image I in memory 103 to generate image J (step S854). CPU 106 reduces image J (step S856).

As shown in FIG. 23(f), CPU 106 causes the reduced image to be displayed in the history region (second region) of touch panel 102 (step S858). CPU 106 ends the second history generating process.

On the other hand, when a hand-drawn image does not exist on the moving image (NO in step S848), CPU 106 determines whether or not the number of pieces of temporary history data is greater than or equal to a prescribed number (step S860). When the number of pieces of temporary history data is greater than or equal to the prescribed number (YES in step S860), CPU 106 deletes the oldest piece of temporary history data from memory 103 (step S862), and adds the generated image to the temporary history data (step S864). CPU 106 ends the second history generating process.

When the number of pieces of temporary history data is less than the prescribed number (NO in step S860), CPU 106 adds the generated image to the temporary history data (step S864). CPU 106 ends the second history generating process.

### <Third History Generating Process in Mobile Phone 100>

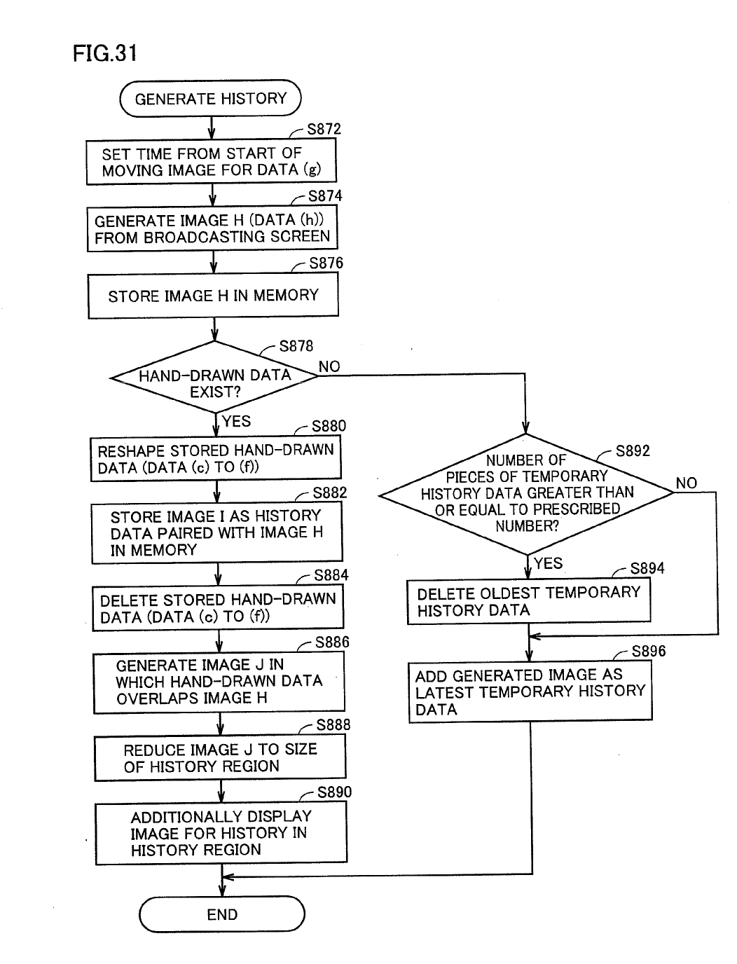

Next, description will be made on the third history generating process in mobile phone 100 according to the present embodiment. FIG. 31 is a flowchart showing a procedure of the third history generating process in mobile phone 100 according to the present embodiment.

As shown in FIGS. 31 and 26(a), CPU 106 sets a time from the start of a moving image to the current time point for data (g) (step S872). As shown in FIGS. 26(b) and 26(c), CPU 106 generates a frame (image H) immediately before the current time point among the frames constituting the moving image contents (step S874).

CPU 106 stores generated image H of moving image contents in memory 103 (step S876). More specifically, CPU 106 associates the time when image H of moving image contents is generated (data (g)) with image H of moving image contents (paint data h), and thus stores them in memory 103.

CPU 106 determines whether or not a hand-drawn image exists on the moving image (step S878). When a hand-drawn image exists on the moving image (YES in step S878), CPU 106 generates draw data (a combination of data (c) to data (0) representing the hand-drawn image being displayed (step S880).

CPU 106 stores the generated image H of moving image contents and draw data in memory 103 (step S882). More specifically, as shown in FIG. 27, CPU 106 associates the time when the history data is generated (data (g)), image H of moving image contents (paint data h) and the draw data (a set of plurality of data groups (c) to (f), and thus stores them in memory 103. It is noted that the time when the history data is generated includes the time when history image J is stored in memory 103. Alternatively, the time when the history data is generated includes a contents reproduction time from the beginning of moving image contents until the frame to be a history image is displayed (a time on the time axis with respect to the starting point of contents). Further alternatively, the time when the history data is generated includes a time from the beginning of moving image contents until the instruction to clear a hand-drawn image is input or a time from the beginning of moving image contents until the scene is changed this time.

CPU 106 deletes the hand-drawn image in memory 103 (step S884). As shown in FIG. 26(d), CPU 106 generates hand-drawn image I from draw data (k) and combines image H of moving image contents with hand-drawn image I in memory 103, thereby generating image J (step S886). CPU 106 reduces image J (step S888).

As shown in FIG. 26(e), CPU 106 causes the reduced image to be displayed in the history region (second region 102B) of touch panel 102 (step S890). CPU 106 ends the third history generating process.

On the other hand, when a hand-drawn image does not exist on the moving image (NO in step S878), CPU 106 determines whether or not the number of pieces of temporary history data is greater than or equal to a prescribed number (step S892). When the number of pieces of temporary history data is greater than or equal to the prescribed number (YES in step S892), CPU 106 deletes the oldest piece of temporary history data from memory 103 (step S894), and adds the generated image to the temporary history data (step S896). CPU 106 ends the third history generating process.

When the number of pieces of temporary history data is less than the prescribed number (NO in step S892), CPU 106 adds the generated image to the temporary history data (step S896). CPU 106 ends the third history generating process.

<Another Application Example of Network System 1 according to Present Embodiment>

It is needless to say that the present invention is also applicable to a case achieved by providing a system or a device with a program. The present invention's effect can also be achieved in such a manner that a storage medium having stored therein a program represented by software for achieving the present invention is provided to a system or a device, and a computer (or CPU or MPU) of the system or device reads and performs a program code stored in the storage medium.

In that case, the program code per se read from the storage medium will implement the function of the above-described embodiments, and the storage medium having the program code stored therein will configure the present invention.

The storage medium for providing the program code can, for example, be a hard disc, an optical disc, a magneto-optical disc, a CD-ROM, a CD-R, a magnetic tape, a non-volatile memory card (an IC memory card), ROMs (mask ROM, flash EEPROM, or the like), or the like.

Furthermore, it is needless to say that not only can the program code read by the computer be executed to implement the function of the above-described embodiments, but a case is also included in which, in accordance with the program code's instruction, an operating system (OS) running on the computer performs an actual process partially or entirely and that process implements the function of the above-described embodiment.

Furthermore, it is also needless to say that a case is also included in which the program code read from the storage medium is written to memory included in a feature expansion board inserted in a computer or a feature expansion unit connected to the computer, and subsequently, in accordance with the program code's instruction, a CPU included in the feature expansion board or the feature expansion unit performs an actual process partially or entirely and that process implements the function of the above-described embodiment.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1 network system; 100, 100A, 100B, 100C mobile phone; 101 communication device; 102 touch panel; 102A first region; 102B second region; 103 memory; 103A work memory; 103B address book data; 103C own terminal's data; 103D address data; 103E address data; 104 pen tablet; 106 CPU; 107 display; 108 microphone; 109 speaker; 110 various types of buttons; 111 first notification unit; 112 second notification unit; 113 TV antenna; 120 stylus pen; 200 car navigation device; 250 vehicle; 300 personal computer; 400 chat server; 406 memory; 406A room management table; 407 fixed disk; 408 internal bus; 409 server communication device; 500 Internet; 600 contents server; 606 memory; 607 fixed disk; 608 Internal bus; 609 server communication device; 615 fixed disk; 700 carrier network.

1. An electronic device comprising:
a memory;
a touch panel on which a background image is displayed; and
a processor for receiving input of a hand-drawn image through said touch panel and causing said touch panel to display said background image and said hand-drawn image to overlap each other, wherein
said processor is configured to:
receive input of an instruction to delete said hand-drawn image superimposed on said background image;
store in said memory as history information, said background image and said hand-drawn image having been displayed on said touch panel when said instruction is input; and
cause said touch panel to display said background image and said hand-drawn image to overlap each other based on said history information.

2. The electronic device according to claim 1, wherein
said touch panel displays a moving image, and
said background image includes a frame of a moving image.

3. The electronic device according to claim 2, wherein, when a scene of said moving image being displayed on said touch panel is changed, said processor stores a frame of said moving image and said hand-drawn image having been displayed on said touch panel immediately before the change, in said memory as said history information.

4. The electronic device according to claim 3, wherein said processor deletes said hand-drawn image on said moving image when the scene of said moving image is changed.

5. The electronic device according to claim 1, wherein said processor deletes said hand-drawn image on said background image in accordance with said instruction.

6. The electronic device according to claim 1, wherein said processor is configured to:
while causing said background image to be displayed in a first region of said touch panel, cause said hand-drawn image to be displayed to overlap said background image; and
cause said background image and said hand-drawn image to be displayed to overlap each other in a second region of said touch panel based on said history information.

7. The electronic device according to claim 1, further comprising an antenna for externally receiving said background image.

8. The electronic device according to claim 1, further comprising a communication interface for communicating with another electronic device via a network, wherein
said processor is configured to:
transmit said hand-drawn image input through said touch panel to said another electronic device via said communication interface, and receives a hand-drawn image from said another electronic device;
cause said touch panel to display said hand-drawn image input through said touch panel and the hand-drawn image from said another electronic device to overlap said background image; and
store said hand-drawn image from said another electronic device in said memory as said history information together with said hand-drawn image input through said touch panel.

9. The electronic device according to claim 1, wherein said processor stores paint data having said hand-drawn image and said background image combined with each other in said memory as said history information.

10. The electronic device according to claim 1, wherein said processor associates paint data showing said hand-drawn image and paint data showing said background image with each other, and stores the associated paint data in said memory as said history information.

11. The electronic device according to claim 1, wherein said processor associates draw data showing said hand-drawn image and paint data showing said background image with each other, and stores the associated draw data and paint data in said memory as said history information.

12. A display method in a computer including a memory, a touch panel and a processor, comprising the steps of:
causing, by said processor, said touch panel to display a background image;
receiving, by said processor, input of a hand-drawn image through said touch panel;
causing, by said processor, said touch panel to display said background image and said hand-drawn image to overlap each other;
receiving, by said processor, input of an instruction to delete said hand-drawn image superimposed on said background image;
storing, by said processor, in said memory as history information, said background image and said hand-drawn image having been displayed on said touch panel when said instruction is input; and
causing, by said processor, said touch panel to display said background image and said hand-drawn image to overlap each other based on said history information.

13. A computer-readable recording medium storing a display program for causing a computer including a memory, a touch panel and a processor to display an image, said display program causing said processor to execute the steps of:
causing said touch panel to display a background image;
receiving input of a hand-drawn image through said touch panel;
causing said touch panel to display said background image and said hand-drawn image to overlap each other;
receiving input of an instruction to delete said hand-drawn image superimposed on said background image;
storing, in said memory as history information, said background image and said hand-drawn image having been displayed on said touch panel when said instruction is input; and
causing said touch panel to display said background image and said hand-drawn image to overlap each other based on said history information.
